(19) United States
(12) Patent Application Publication
(10) Pub. No.: US 2026/0119982 A1
(43) Pub. Date: Apr. 30, 2026

(54) MACHINE LEARNING MODEL PROMPT GENERATION BASED ON MOBILE ROBOT DATA

(71) Applicant: Boston Dynamics, Inc., Waltham, MA (US)

(72) Inventors: Matthew Jacob Klingensmith, Somerville, MA (US); Mario Attilio Bollini, Somerville, MA (US); Michael James McDonald, Cambridge, MA (US)

(21) Appl. No.: 19/003,762

(22) Filed: Dec. 27, 2024

Related U.S. Application Data
(60) Provisional application No. 63/571,954, filed on Mar. 29, 2024.

(51) Int. Cl. G06N 20/00; B25J 9/16; B62D 57/032; G05D 1/225; G05D 101/15

(52) U.S. Cl. CPC G06N 20/00; G05D 1/225; B25J 9/1671; B62D 57/032; G05D 2101/15

(57) ABSTRACT

Systems and methods are described for machine learning model prompt generation based on mobile robot data. A system may obtain log data associated with one or more mobile robots. For example, the log data may include sensor data obtained via one or more sensors of the one or more mobile robots. The system may generate a prompt for a machine learning model, the prompt may be based on an obtained input and may include at least a portion of the log data. For example, the prompt may include one or more questions based on the obtained input. The system may provide the prompt to a computing system and obtain an output from the computing system. The system may instruct performance of one or more actions based on the output.

### CROSS REFERENCE TO RELATED APPLICATION

This U.S. patent application claims priority under 35 U.S.C. § 119 (e) to U.S. Provisional Application No. 63/571,954, filed Mar. 29, 2024, which is considered part of the disclosure of this application and is hereby incorporated by reference in its entirety.

### TECHNICAL FIELD

This disclosure relates generally to robotics, and more specifically, to systems, methods, and apparatuses, including computer programs, for dynamic generation of prompts for machine learning models based on mobile robot data.

### BACKGROUND

Robotic devices can autonomously or semi-autonomously navigate environments (e.g., sites) to perform a variety of tasks or functions. The robotic devices can generate data based on navigating the environments. As robotic devices become more prevalent, there is a need to enable the robotic devices to perform actions based on that data in a dynamic manner. For example, there is a need to enable the robotic devices to perform actions, in a safe and reliable manner, based on the data.

### SUMMARY

An aspect of the present disclosure provides a method that may include obtaining, by data processing hardware, log data associated with one or more mobile robots. The one or more mobile robots may be configured to traverse an environment. The method may further include generating, by the data processing hardware, a prompt for a machine learning model. The prompt for the machine learning model may include at least a portion of the log data and one or more questions. The method may further include providing, by the data processing hardware, the prompt for the machine learning model to a computing system. The method may further include obtaining, by the data processing hardware, an output from the computing system. The output may include one or more responses to the prompt for the machine learning model. The method may further include instructing, by the data processing hardware, performance of one or more actions based on the output.

In various embodiments, the prompt for the machine learning model may indicate that the at least a portion of the log data is associated with the one or more mobile robots.

In various embodiments, the prompt for the machine learning model may indicate that the at least a portion of the log data is associated with the one or more mobile robots within a particular proximity of a ground surface.

In various embodiments, the prompt for the machine learning model may indicate that the at least a portion of the log data is associated with the one or more mobile robots traversing the environment.

In various embodiments, the prompt for the machine learning model may indicate that the at least a portion of the log data is associated with one or more sensors of one or more mobile robots.

In various embodiments, the prompt for the machine learning model may indicate that the at least a portion of the log data is associated with the one or more mobile robots and each of the one or more mobile robots may include two or more legs.

In various embodiments, the one or more questions may include one or more questions requesting a comparison of two or more objects as indicated by the at least a portion of the log data.

In various embodiments, the one or more questions may include one or more multiple choice questions.

In various embodiments, the prompt may further include at least one of sensor data or synthetic image data.

In various embodiments, the log data may include image data.

In various embodiments, the log data may include a plurality of images. The log data may indicate a timestamp for each of the plurality of images.

In various embodiments, the log data may include image data. The one or more questions may include one or more questions requesting a comparison of at least a first image of the image data to a second image of the image data.

In various embodiments, the log data may include sensor data and one or more parameters. The method may further include filtering the log data to identify the at least a portion of the log data based on the one or more parameters.

In various embodiments, the log data may include sensor data and one or more parameters. The one or more parameters may indicate the one or more mobile robots stopped for a moving object. The method may further include filtering the log data to identify the at least a portion of the log data based on the one or more parameters.

In various embodiments, the log data may include sensor data and one or more parameters. The one or more parameters may indicate the one or more mobile robots stopped for a moving object. The method may further include filtering the log data to identify the at least a portion of the log data based on the one or more parameters. The one or more responses may indicate at least one of a presence, class, or status of an object around a respective robot of the one or more mobile robots.

In various embodiments, the log data may be segmented into a plurality of data buckets. Each of the plurality of data buckets may be associated with a respective parameter. The method may further include filtering the log data to identify the at least a portion of the log data associated with a particular data bucket of the plurality of data buckets. The at least a portion of the log data may include a portion of the log data segmented into the particular data bucket. The prompt may further include a particular parameter associated with the particular data bucket.

In various embodiments, the log data may be segmented into a plurality of data buckets. Each of the plurality of data buckets may be associated with a respective parameter. The method may further include filtering the log data to identify the at least a portion of the log data associated with a particular data bucket of the plurality of data buckets. The at least a portion of the log data may include a portion of the log data segmented into the particular data bucket. The prompt may further include a particular parameter associated with the particular data bucket. Instructing performance of the one or more actions may include identifying segmentation of the portion of the log data into the particular data bucket is associated with at least one false positive based on the output. Instructing performance of the one or more actions may further include removing the portion of the log data from the particular data bucket based on identifying the segmentation of the portion of the log data into the particular data bucket is associated with the at least one false positive.

In various embodiments, instructing performance of the one or more actions may include providing the output to a database.

In various embodiments, the log data may be associated with a particular data bucket of a plurality of data buckets. Each of the plurality of data buckets may be associated with a respective parameter. Instructing performance of the one or more actions may include identifying association of a portion of the log data and the particular data bucket is associated with at least one false positive based on the output. Instructing performance of the one or more actions may further include disassociating the portion of the log data and the particular data bucket based on identifying the association of the portion of the log data and the particular data bucket is associated with at least one false positive.

In various embodiments, the log data may correspond to a particular data bucket of a plurality of data buckets. Each of the plurality of data buckets may be associated with a respective parameter. Instructing performance of the one or more actions may include identifying association of a portion of the log data and the particular data bucket is associated with at least one false positive based on the output. Instructing performance of the one or more actions may further include removing the portion of the log data from the particular data bucket based on identifying the association of the portion of the log data and the particular data bucket is associated with at least one false positive. Instructing performance of the one or more actions may further include adding the portion of the log data to a different data bucket of the plurality of data buckets.

In various embodiments, the log data may be segmented into a plurality of data buckets. Each of the plurality of data buckets may be associated with a respective event and at least one timestamp indicative of an occurrence of the respective event. The method may further include filtering the log data to identify the at least a portion of the log data associated with a particular data bucket of the plurality of data buckets.

In various embodiments, the log data may corresponds to a particular data bucket of a plurality of data buckets. Each of the plurality of data buckets may be associated with a respective event and at least one timestamp indicative of an occurrence of the respective event. The method may further include identifying a timestamp associated with the particular data bucket. The method may further include filtering the log data based on the timestamp to identify the at least a portion of the log data.

In various embodiments, the log data may include a plurality of images corresponding to a particular data bucket of a plurality of data buckets. Each of the plurality of data buckets may be associated with a respective event and at least one timestamp indicative of an occurrence of the respective event. The method may further include identifying a timestamp associated with the particular data bucket. The method may further include filtering the plurality of images based on the timestamp to obtain a filtered plurality of images corresponding to the at least a portion of the log data. The filtered plurality of images may include a first image of the plurality of images and may exclude a second image of the plurality of images.

In various embodiments, the log data may include a plurality of images corresponding to a particular data bucket of a plurality of data buckets. Each of the plurality of data buckets may be associated with a respective event and at least one timestamp indicative of an occurrence of the respective event. The method may further include identifying a timestamp associated with the particular data bucket. The method may further include filtering the plurality of images based on a temporal proximity of the plurality of images to the timestamp to obtain a filtered plurality of images corresponding to the at least a portion of the log data.

In various embodiments, the computing system may implement the machine learning model.

In various embodiments, the machine learning model may include a visual question answering model.

In various embodiments, instructing performance of the one or more actions may include filtering the at least a portion of the log data based at least in part on the output.

In various embodiments, instructing performance of the one or more actions may include transforming the output based on the prompt to identify a transformed output. Instructing performance of the one or more actions may further include providing the transformed output to a database.

In various embodiments, instructing performance of the one or more actions may include providing the output to a database. Instructing performance of the one or more actions may further include providing, to a user computing device, access to the database.

In various embodiments, instructing performance of the one or more actions may include providing the output to a database. Instructing performance of the one or more actions may further include providing, to a user computing device, a link to the database.

In various embodiments, instructing performance of the one or more actions may include providing the output to a user computing device.

In various embodiments, instructing performance of the one or more actions may include instructing display of the output via a user interface of a user computing device.

In various embodiments, instructing performance of the one or more actions may include generating a second output based on the prompt for the machine learning model and the output. Instructing performance of the one or more actions may further include instructing display of the second output via a user interface of a user computing device.

In various embodiments, instructing performance of the one or more actions may include generating a spatially augmented output based on the prompt for the machine learning model and the output. Instructing performance of the one or more actions may further include instructing display of the spatially augmented output overlaid on a pictorial representation of the environment of the one or more mobile robots via a user interface of a user computing device.

In various embodiments, generating the prompt for the machine learning model may include generating the prompt for the machine learning model based on an input.

In various embodiments, generating the prompt for the machine learning model may include obtaining, from a user computing device, an input. Generating the prompt for the machine learning model may further include generating the prompt for the machine learning model based on the input.

In various embodiments, obtaining the log data may include searching a plurality of data buckets to obtain the log data.

In various embodiments, obtaining the log data may include obtaining, from a user computing device, an input. Obtaining the log data may further include searching a plurality of data buckets to obtain the log data based on the input.

In various embodiments, generating the prompt for the machine learning model may include dynamically generating the prompt for the machine learning model.

In various embodiments, the one or more mobile robots may implement one or more machine learning models. Instructing performance of the one or more actions may include training the one or more machine learning models based on the output.

In various embodiments, the one or more mobile robots may implement one or more machine learning models. Instructing performance of the one or more actions may include identifying one or more false positives associated with the log data based on the output. Instructing performance of the one or more actions may further include training the one or more machine learning models based on the one or more false positives.

In various embodiments, instructing performance of the one or more actions may include instructing performance of the one or more actions by the one or more mobile robots based on the output.

In various embodiments, instructing performance of the one or more actions may include instructing performance of one or more actions by a mobile robot based on the output.

In various embodiments, instructing performance of the one or more actions may include instructing traversal of the environment by the one or more mobile robots based on the output. Instructing performance of the one or more actions may further include instructing generation of additional log data by the one or more mobile robots based on the traversal of the environment.

In various embodiments, instructing performance of the one or more actions may include identifying one or more log data generation criteria based on the output. Instructing performance of the one or more actions may further include instructing traversal of the environment by the one or more mobile robots based on the output. Instructing performance of the one or more actions may further include instructing generation of additional log data by the one or more mobile robots based on the traversal of the environment and the one or more log data generation criteria.

In various embodiments, instructing performance of the one or more actions may include identifying one or more log data generation criteria based on the output. The one or more log data generation criteria may indicate one or more of a portion of the environment for generation of log data, a time period for generation of log data, a sensor of the one or more mobile robots for generation of log data, sensor data for generation of log data, a state of the one or more mobile robots for generation of log data, an object for generation of log data, an obstacle for generation of log data, a structure for generation of log data, or an entity for generation of log data. Instructing performance of the one or more actions may further include instructing traversal of the environment by the one or more mobile robots based on the output. Instructing performance of the one or more actions may further include instructing generation of additional log data by the one or more mobile robots based on the traversal of the environment and the one or more log data generation criteria.

In various embodiments, obtaining the log data may include obtaining a first portion of the log data from a first mobile robot of the one or more mobile robots and a second portion of the log data from a second mobile robot of the one or more mobile robots. The first portion of the log data may be captured via one or more first sensors of the first mobile robot and the second portion of the log data may be captured via one or more second sensors of the second mobile robot.

In various embodiments, the method may further include filtering the log data to identify the at least a portion of the log data.

In various embodiments, the log data may include a plurality of images. The method may further include filtering the plurality of images to identify a first image of the plurality of images. The at least a portion of the log data may include the first image.

In various embodiments, the log data may include a plurality of images. The method may further include filtering the plurality of images to identify a portion of a first image of the plurality of images. The at least a portion of the log data may include the portion of the first image.

In various embodiments, the method may further include filtering the log data to identify the at least a portion of the log data based on one or more values of the log data.

In various embodiments, the method may further include filtering the log data to identify the at least a portion of the log data based on one or more values of the log data indicating a fall of the one or more mobile robots.

In various embodiments, the method may further include filtering the log data to identify the at least a portion of the log data based on one or more values of the log data indicating the one or more mobile robots are stuck.

In various embodiments, the method may further include filtering the log data to identify the at least a portion of the log data based on one or more values of the log data indicating the one or more mobile robots are lost.

In various embodiments, the method may further include filtering the log data to identify the at least a portion of the log data based on one or more values of the log data indicating the one or more mobile robots are unable to dock.

In various embodiments, the method may further include filtering the log data to identify the at least a portion of the log data based on one or more values of the log data indicating the one or more mobile robots turned off.

In various embodiments, the method may further include filtering the log data to identify the at least a portion of the log data based on one or more values of the log data indicating initiation of a recording operation associated with the one or more mobile robots.

In various embodiments, instructing performance of the one or more actions may include annotating the log data based on the output to obtain annotated log data. Instructing performance of the one or more actions may further include providing the annotated log data to a database.

In various embodiments, the output may include at least one of a flag, an alert, a visual sort, visual top K, or a ranking.

In various embodiments, the output may include an alert of an anomalous condition.

In various embodiments, the output may indicate the at least a portion of the log data is associated with a false positive.

In various embodiments, the one or more responses may include one or more responses in JSON data format.

In various embodiments, the one or more mobile robots may include one or more quadruped robots.

According to various embodiments of the present disclosure, a system may include data processing hardware and memory in communication with the data processing hardware. The memory may store instructions that when executed on and/or by the data processing hardware may cause the data processing hardware to obtain log data associated with one or more mobile robots. The one or more mobile robots may be configured to traverse an environment. Execution of the instructions on and/or by the data processing hardware may further cause the data processing hardware to generate a prompt for a machine learning model. The prompt for the machine learning model may include at least a portion of the log data and one or more questions. Execution of the instructions on and/or by the data processing hardware may further cause the data processing hardware to provide the prompt for the machine learning model to a computing system. Execution of the instructions on and/or by the data processing hardware may further cause the data processing hardware to obtain an output from the computing system. The output may include one or more responses to the prompt for the machine learning model. Execution of the instructions on and/or by the data processing hardware may further cause the data processing hardware to instruct performance of one or more actions based on the output.

In various embodiments, the system may further include any combination of the features discussed herein.

According to various embodiments of the present disclosure, a robot may include at least one sensor, at least two legs, data processing hardware in communication with the at least one sensor, and memory in communication with the data processing hardware. The memory may store instructions that when executed on and/or by the data processing hardware may cause the data processing hardware to obtain log data associated with one or more mobile robots. The one or more mobile robots may be configured to traverse an environment. Execution of the instructions on and/or by the data processing hardware may further cause the data processing hardware to generate a prompt for a machine learning model. The prompt for the machine learning model may include at least a portion of the log data and one or more questions. Execution of the instructions on and/or by the data processing hardware may further cause the data processing hardware to provide the prompt for the machine learning model to a computing system. Execution of the instructions on and/or by the data processing hardware may further cause the data processing hardware to obtain an output from the computing system. The output may include one or more responses to the prompt for the machine learning model. Execution of the instructions on and/or by the data processing hardware may further cause the data processing hardware to instruct performance of one or more actions based on the output.

In various embodiments, the robot may further include any combination of the features discussed herein.

According to various embodiments of the present disclosure, a method may include instructing, by data processing hardware, a mobile robot to perform one or more operations. Performance of the one or more operations may cause the mobile robot to generate log data. The method may further include obtaining, by the data processing hardware, the log data. The method may further include identifying, by the data processing hardware, one or more questions. The method may further include providing, by the data processing hardware, the log data and the one or more questions to a first computing system. The method may further include obtaining, by the data processing hardware, an output from the first computing system. The output may include one or more responses to the one or more questions. The method may further include providing, by the data processing hardware, the output to a second computing system.

According to various embodiments of the present disclosure, a method may include obtaining, by data processing hardware, log data associated with one or more mobile robots. The method may further include obtaining, by the data processing hardware, from a user computing device, an input. The input may indicate a visual comparison operation. The method may further include dynamically generating, by the data processing hardware, a prompt based on the log data and the input. The method may further include providing, by the data processing hardware, the prompt to a computing system. The method may further include obtaining, by the data processing hardware, an output from the computing system. The method may further include instructing display, by the data processing hardware, via the user computing device, of a user interface based on the output. The user interface may indicate performance of the visual comparison operation.

According to various embodiments of the present disclosure, a method may include obtaining, by data processing hardware, image data associated with one or more mobile robots. The method may further include obtaining, by the data processing hardware, sensor data associated with the one or more mobile robots. The method may further include generating, by the data processing hardware, text data based on the sensor data. The text data may include one or more textual values based on the sensor data. The method may further include providing, by the data processing hardware, the text data and the image data to a computing system. The method may further include obtaining, by the data processing hardware, an output from the computing system. The method may further include providing, by the data processing hardware, the output to a database.

According to various embodiments of the present disclosure, a method may include obtaining, by data processing hardware, log data associated with one or more mobile robots. The log data may be based on one or more operations performed by the one or more mobile robots within an environment. The method may further include providing, by the data processing hardware, at least a portion of the log data to a computing system. The method may further include obtaining, by the data processing hardware, an output from the computing system. The method may further include generating a digital twin of the environment based on the output. The method may further include instructing display, by the data processing hardware, of the digital twin via a user interface of a user computing device.

According to various embodiments of the present disclosure, a method may include obtaining, by data processing hardware, log data associated with one or more mobile robots. The method may further include providing, by the data processing hardware, at least a portion of the log data and one or more questions to a first computing system. The method may further include obtaining, by the data processing hardware, an output from the first computing system. The method may further include filtering, by the data processing hardware, the log data based on the output to identify filtered log data. The method may further include providing, by the data processing hardware, the filtered log data to a second computing system.

According to various embodiments of the present disclosure, a system may include data processing hardware and memory in communication with the data processing hardware. The memory may store instructions that when executed on and/or by the data processing hardware cause the data processing hardware to perform any combination of the features discussed herein.

According to various embodiments of the present disclosure, a robot may include at least one sensor, at least two legs, data processing hardware in communication with the at least one sensor, and memory in communication with the data processing hardware. The memory may store instructions that when executed on and/or by the data processing hardware cause the data processing hardware to perform any combination of the features discussed herein.

The details of the one or more implementations of the disclosure are set forth in the accompanying drawings and the description herein. Other aspects, features, and advantages will be apparent from the description and drawings, and from the claims.

### DESCRIPTION OF DRAWINGS

FIG. 1A is a schematic view of an example robot for navigating an environment.

FIG. 1B is a schematic view of a navigation system for navigating the robot of FIG. 1A.

FIG. 2 is a schematic view of exemplary components of a navigation system of a robot.

FIG. 3 is a schematic view of a topological map.

FIG. 4 is a schematic view of a plurality of systems of the robot of FIG. 1A.

FIG. 5A is an operation diagram illustrating a data flow for operations for filtering log data.

FIG. 5B is an operation diagram illustrating a data flow for operations for generating an output based on filtered log data.

FIG. 6A is a schematic view of log data associated with a robot.

FIG. 6B is a schematic view of annotated log data associated with a robot.

FIG. 7 is a schematic view of a user interface for providing an input for generation of a prompt.

FIG. 8A is a schematic view of a user interface for providing a transformed output based on an implemented prompt.

FIG. 8B is a schematic view of a user interface for providing a transformed output based on an implemented prompt.

FIG. 8C is a schematic view of a user interface for providing a transformed output based on an implemented prompt.

FIG. 9 is a flowchart of an example arrangement of operations for instructing performance of one or more actions based on a generated and implemented prompt.

FIG. 10 is a schematic view of an example computing device that may be used to implement the systems and methods described herein.

Like reference symbols in the various drawings indicate like elements.

### DETAILED DESCRIPTION

Generally described, autonomous and semi-autonomous robots can utilize mapping, localization, and navigation systems to map an environment utilizing data associated with the robots (e.g., robot data, mobile robot data, etc.). The robots can obtain the data (e.g., sensor data) from one or more components of the robots (e.g., sensors, sources, outputs, etc.). For example, the robots can obtain sensor data from an image sensor, a lidar sensor, a ladar sensor, a radar sensor, pressure sensor, an accelerometer, a battery sensor (e.g., a voltage meter), a speed sensor, a position sensor, an orientation sensor, a pose sensor, a tilt sensor, a clock, and/or any other component of the robot. Further, the sensor data may include image data, lidar data, ladar data, radar data, pressure data, acceleration data, battery data (e.g., voltage data), speed data, position data, orientation data, pose data, tilt data, time data, temperature data, etc.

The robots can utilize the mapping, localization, and navigation systems and the obtained data to perform mapping, localization, and/or navigation in the environment and build navigation graphs that identify route data (e.g., indicative of a route through the environment) based on identified features representing entities, objects, obstacles, or structures within the environment.

The robot may store the data (e.g., sensor data) as log data (e.g., in one or more data buckets, data bundles, data stores, databases, files, buckets, collections of data, etc.). For example, the robot may store the data as log data in a local data store or a remote data store. It will be understood that while reference may be made to log data stored in data buckets, the log data may be stored in any storage for data.

In some cases, a plurality of robots may store data as log data in the same data bucket or different data buckets. For example, a plurality of robots may store data associated with (e.g., captured in) the same environment or different environment as log data in one or more data buckets.

In some cases, one or more robots may generate log data based on the data and may provide the generated log data to a computing system that may store the log data in one or more data buckets. The robot may generate the log data (e.g., a plurality of logs) based on the data (e.g., all or a portion of the plurality of logs may include a portion of the data). For example, the robot may generate log data that includes image data, lidar data, ladar data, radar data, pressure data, acceleration data, battery data (e.g., voltage data), speed data, position data, orientation data, pose data, tilt data, time data, temperature data, etc. In some cases, the robot may build one or more logs and all or a portion of the one or more logs may include one or more respective fields and one or more respective field values. The robot may store the one or more logs as the log data. For example, a first field of the log may be a time field, a second field of the log may be an acceleration field, a first field value of the log may be a time value, a second field value of the log may be an acceleration value, etc.

In some cases, one or more robots may provide the data to a computing system and the computing system may generate and store the log data in one or more data buckets based on the provided data.

In some cases, the robot (or a separate system) may periodically and/or continuously update the log data stored in one or more data buckets. For example, the robot may store log data in the one or more data buckets as data is obtained by the robot.

In some cases, the log data (and/or the data) and the one or more data buckets may be associated with (e.g., may include, may be assigned, may indicate, etc.) one or more parameters (e.g., tags, annotations, labels, etc.). For example, the log data (and/or the data) may include parameter data (e.g., tag data, annotation data, label data, etc.) indicating one or more parameters associated with the log data (and/or the data) and all or a portion of the one or more data buckets may be assigned one or more respective parameters. The one or more parameters may indicate an event, an action, an object, an obstacle, a structure, an entity, a time, particular data, etc. associated with a robot. For example, the one or more parameters may indicate the robot grasped an item, turned a lever, falls, is lost, is stuck, fails to dock, turns off, turns on, started capturing sensor data, stopped capturing sensor data, etc.

In some cases, the robot (or a separate system) may generate the one or more parameters associated with the log data (and/or may associate the one or more parameters with the log data). For example, the robot may implement a machine learning model (e.g., trained to output one or more parameters based on input log data). The robot may provide the log data to the machine learning model and may obtain the parameters from the machine learning model.

The robot (or a separate system) may store the log data in the one or more data buckets based on the one or more parameters associated with the log data. For example, the robot may determine a first parameter is associated with a set of log data (e.g., 1 gigabyte of data) and may store the set of log data in a data bucket that is associated with the first parameter. The robot may generate a set of data when an event corresponding to a particular parameter occurs (e.g., the robot falls, the robot slips, the robot detects an entity within a particular proximity of the robot, etc.) and the set of data for storage in a data bucket may include data captured during a time period before (e.g., 30 seconds before) the event and data captured during a time period after (e.g., 30 seconds after) the event.

The present disclosure relates to prompt generation for a machine learning model based on the data associated with the robot to identify actions to be performed based on the data associated with the robot. For example, the data associated with a robot may include sensor data, log data, etc. The data associated with the robot may be referred to herein as log data, however, it will be understood that the data may include any data associated with a robot (e.g., sensor data).

A computing system can obtain the log data. In some cases, the computing system can obtain the log data as stored in one or more data buckets. For example, a robot may store the log data in one or more data buckets and the computing system may obtain the log data from the one or more data buckets as stored by the robot.

In some cases, the computing system may obtain the log data in real time. For example, the computing system may obtain the log data in real time from one or more robots (e.g., directly from one or more robots).

In some cases, to obtain the log data, the computing system may identify the data buckets associated with the log data (e.g., the data buckets in which the log data is stored or is to be stored). For example, the computing system may identify a respective portion of the log data corresponds to (e.g., is stored) in all or a portion of a plurality of data buckets. The computing system may identify the data buckets corresponding to the log data and may obtain the log data from the identified data buckets.

In some cases, the robot (or a separate system) may store the log data in the data buckets according to the parameters of the log data. All or a portion of the data buckets may correspond to a respective parameter associated with the log data corresponding to (e.g., stored in, included within, etc.) the particular data bucket. For example, a first data bucket may correspond to a first parameter indicating that log data stored in (e.g., included within) the first data bucket is log data corresponding to sensor data captured at night, a second data bucket may correspond to a second parameter indicating that log data stored in the second data bucket is log data associated with a fall (e.g., log data tagged as being associated with a fall), a third data bucket may correspond to a third parameter indicating that log data stored in the third data bucket is log data associated with detection of an entity (e.g., a human), another robot, etc. within a particular radius (e.g., 1 meter) of the robot, etc.

In some cases, the computing system may obtain the log data (e.g., from the robot) and may store the log data in the one or more data buckets (e.g., the computing system may categorize the log data and store the log data in a corresponding data bucket based on the categorization). For example, the computing system may process the log data to identify one or more parameters of the log data and may store the log data in one or more data buckets based on the one or more parameters of the log data. In another example, the computing system may filter the log data based on the one or more parameters of the log data to identify filtered log data associated with one or more parameters and may store the filtered log data in the data buckets.

The computing system (or another system) may designate a particular data bucket for performance of a particular action based on the corresponding log data associated with the particular data bucket (e.g., routing of the corresponding data for review). For example, to designate a particular data bucket, the computing system may flag a particular data bucket, generate an alert based on a particular data bucket, etc.

Based on designating the particular data bucket, the computing system may route an identifier of the particular data bucket, an identifier of the corresponding log data associated with the particular data bucket, the corresponding log data, etc. For example, the computing system may route the corresponding log data to a user computing device for review of the corresponding log data. In some cases, the computing system may route the identifier of the particular data bucket, the identifier of the corresponding log data, the corresponding log data, etc. to a user computing device and may cause display of the identifier of the particular data bucket, the identifier of the corresponding log data, the corresponding log data, etc. via a user interface of the user computing device.

In some cases, based on designation of a particular data bucket (e.g., for review), the computing system may apply a corresponding designation to log data associated with the particular data bucket. For example, the computing system may designate a data bucket for review that is associated with falls of the robot and may designate the log data stored in the data bucket to be routed to a user computing device for review. In some cases, the computing system may route the log data to the user computing device for review based on designating the log data to be routed to the user computing device.

As log data may be tagged with a parameter and stored in a data bucket in error such that all of the log data associated with the data bucket (including log data erroneously tagged) may be designated for performance of an action (which may cause issues and/or inefficiencies (including computational inefficiencies, a loss of confidence in the systems and/or the robot, etc.)), validation (e.g., verification) that the log data was correctly tagged may reduce the amount of data for performance of an action (e.g., from multiple gigabytes of data to less than a gigabyte of data). For example, log data may be erroneously tagged to indicate that an entity (e.g., a person) was indicated within a particular radius of a robot while the log data does not indicate that an entity was within the particular radius (e.g., image data of the log data does not depict an entity within the particular radius).

In some cases, a user may attempt to manually review the log data and cause performance of an action based on the manual review (e.g., flag a portion of the log data for further review by another user, a model, etc.). However, such a manual review of the log data may not be possible as a robot may generate a large amount of log data (e.g., terabytes of log data). Additionally, the log data stored in the data buckets may correspond to a plurality of robots (e.g., hundreds of robots, thousands of robots, etc.) and may correspond to a time period (e.g., hours, days, months, etc.) such that the log data may include a large amount of data (e.g., a large amount of data may be stored in the one or more data buckets) and it may not be possible to manually review the log data. Such a manually process may cause issues and/or inefficiencies (e.g., movement inefficiencies) as the performed action may be based on an erroneous interpretation of the log data (e.g., by the user). Further, such a manual process may be resource and time intensive and inefficient based on the amount of data associated with a robot(s).

The methods and apparatus described herein enable a system to dynamically generate a prompt for a machine learning model based on the log data and an input (e.g., a user input). The system can obtain an output from another system (e.g., implementing the machine learning model) and may cause performance of an action based on the output (e.g., may route the output to a database).

As components (e.g., mobile robots) proliferate, the demand for dynamic performance of actions by the computing system based on log data has increased. Specifically, the demand for robots to identify log data associated with the robots, filter the log data associated with the robots, and perform an action based on the filtered log data has increased. For example, the computing system may store log data in data buckets based on the parameters (e.g., tags) of the log data. The computing system may process (e.g., filter) the log data based on the data and perform an action based on processing the log data. The present disclosure provides systems and methods that enable an increase in the accuracy and efficiency in the performance of the actions (e.g., identifying and routing a portion of the log data for review).

Further, the present disclosure provides systems and methods that enable a reduction in the time and user interactions, relative to traditional embodiments, to perform actions based on the log data (e.g., a review of the log data) without significantly affecting the power consumption or speed of the robot. These advantages are provided by the embodiments discussed herein, and specifically by implementation of a process that includes the dynamic generation of a prompt for a machine learning model based on the log data. By dynamically generating a prompt for a machine learning model, systems can identify how to process the log data and an action to perform. For example, the systems may identify a particular portion of the data, filter the data to obtain filtered data corresponding to the portion of data, and route the filtered data for review, instead of routing the unfiltered data for review.

As described herein, the process of performing actions based on dynamically generating a prompt for a machine learning model may include obtaining log data associated with one or more robots (e.g., sensor data generated by the one or more robots via one or more sensors of the one or more robots). For example, a computing system may obtain log data including first sensor data corresponding to a first robot (e.g., generated by the first robot via one or more first sensors), second sensor data corresponding to a second robot (e.g., generated by the second robot via one or more second sensors), third sensor data corresponding to a third robot (e.g., generated by the third robot via one or more third sensors), etc. It will be understood that the log data may include data corresponding to any number of robots. The computing system may obtain the log data from the one or more robots, from a shared data store, from an intermediary computing system.

As discussed herein, the computing system (or a separate system) may obtain the log data and process the log data. For example, the computing system may process the log data to identify parameters of the log data. In some cases, the computing system may store the log data in one or more data buckets based on processing the log data (e.g., based on the identified parameters of the log data). To store the log data in one or more data buckets, the computing system may filter the log data to identify filtered log data associated with a particular parameter and may store the filtered log data in a data bucket corresponding to the same parameter.

In some cases, the computing system may obtain an input (e.g., a user input). For example, the computing system may obtain the input from a user computing device. The input may include one or more requests (e.g., one or more questions, commands, etc.). The input may include a request to perform an action based on the log data. For example, the input may include a request to identify log data associated with a robot fall, identify log data where the log data is tagged as being associated with a robot fall, but the log data is not associated with a robot fall, a request to identify a particular object, obstacle, entity, or structure within an environment, etc. In another example, the input may include a request to identify a particular object, obstacle, entity, or structure (e.g., a wrench, a lever, a wheel, etc.) identified within the log data and generate a comparison of one or more characteristics of the particular object, obstacle, entity, or structure (e.g., a comparison of the condition, the age, the size, the orientation, etc.) compared to other objects, obstacles, entities, or structures (e.g., having the same type) that are identified within the log data, generate a representation of the environment based on the log data, etc.

Based on the input and the log data, the computing system may generate (e.g., dynamically generate) a prompt (e.g., a text prompt) for a machine learning model. For example, the computing system may perform prompt engineering to generate the prompt. The prompt may include a portion of the log data (e.g., a portion of image data) and the input (e.g., one or more requests from the input). For example, the prompt may include a portion of the log data that corresponds to a particular data bucket. In some cases, the portion of the log data may include image data and text data (e.g., including one or more textual values) based on non-image data (e.g., pressure data, acceleration data, battery data, speed data, position data, orientation data, pose data, tilt data, time data, temperature data, etc.). As the portion of the log data that corresponds to a particular bucket may be a filtered portion of the log data (e.g., the log data may be filtered and divided across a plurality of data buckets), the prompt may include the filtered log data.

In some cases, to generate the prompt, the computing system may include contextual data associated with the log data within the generated prompt. For example, the computing system may include contextual data within the generated prompt indicating that the log data is associated with a legged robot, is associated with one or more sensors of a legged robot directed at a floor, is associated with a robot that is operating in an environment with other robots, etc. As the machine learning model implementing the prompt may not be trained on mobile robot data, the computing system may include the contextual data to improve the effectiveness and efficiency of the machine learning model by providing context of the log data to the machine learning model.

The computing system may provide the generated prompt to a second computing system. The second computing system may implement a machine learning model. For example, the second computing system may implement and/or execute a visual question answering machine learning model (e.g., a visual foundation machine learning model). In some cases, the computing system may provide, to the second computing system, the generated prompt and instructions to provide the generated prompt to the machine learning model.

In some cases, the computing system may implement and/or execute the machine learning model. For example, the computing system may implement the machine learning model (e.g., locally) and may provide the generated prompt to the machine learning model as implemented by the computing system. In some cases, the computing system may generate and provide the prompt to the machine learning model prior to storing the corresponding log data in one or more data buckets (e.g., and may store the corresponding log data in a data bucket based on the output of the machine learning model).

In some cases, the computing system may identify data associated with the machine learning model. For example, the computing system may identify a configuration of the machine learning model indicating a format of input to the machine learning model. The computing system may generate the prompt for the machine learning model based on the identified data associated with the machine learning model. The computing system may generate the prompt for the machine learning model in a format such that the prompt is readable by the machine learning model. For example, the computing system may generate the prompt according to a particular computing language or data format.

Based on providing the prompt for the machine learning model to the second computing system, the computing system may obtain an output of the second computing system. The output may include a response to the requests as indicated by the input. For example, the output may include image data, text data, log data, etc. In some cases, the output may include and/or may be indicative of a portion of the log data included within the generated prompt (e.g., a portion of the log data corresponding to a particular data bucket).

The computing system may obtain the output of the second computing system and perform one or more actions based on the output. In some cases, the one or more actions may include routing the output and/or causing display of the output. For example, the computing system may route the output to a data store (e.g., a data base, a user computing device, etc.).

In some cases, the one or more actions may include routing the output to a computing device for annotation of corresponding image data. For example, the output may indicate one or more images and the one or more actions may include routing the one or more images to a user computing device for annotation of the one or more images.

In some cases, the one or more actions may include generating an alert and/or flagging a portion of the log data based on the output. For example, the output may indicate log data that was tagged with a particular parameter but is not associated with the parameter (e.g., based on the machine learning model). The computing system may generate an alert based on determining that the log data was tagged with a particular parameter but is not associated with the parameter and may route the alert to a user computing device.

In some cases, the one or more actions may include training and/or validating a system based on the output. For example, the output may indicate log data that was tagged with a particular parameter but the log data may not be associated with the parameter (e.g., based on the machine learning model) and the computing system may train a second machine learning model based on the output. In some cases, the log data may be tagged with a particular parameter based on a second machine learning model and the computing system may train the second machine learning model based on the output.

In some case, the one or more actions may include generating a second output based on the output. For example, the output may include a portion of the image data and the computing system may generate a second output (e.g., a visual representation of an environment, a graph, etc.) based on the image data.

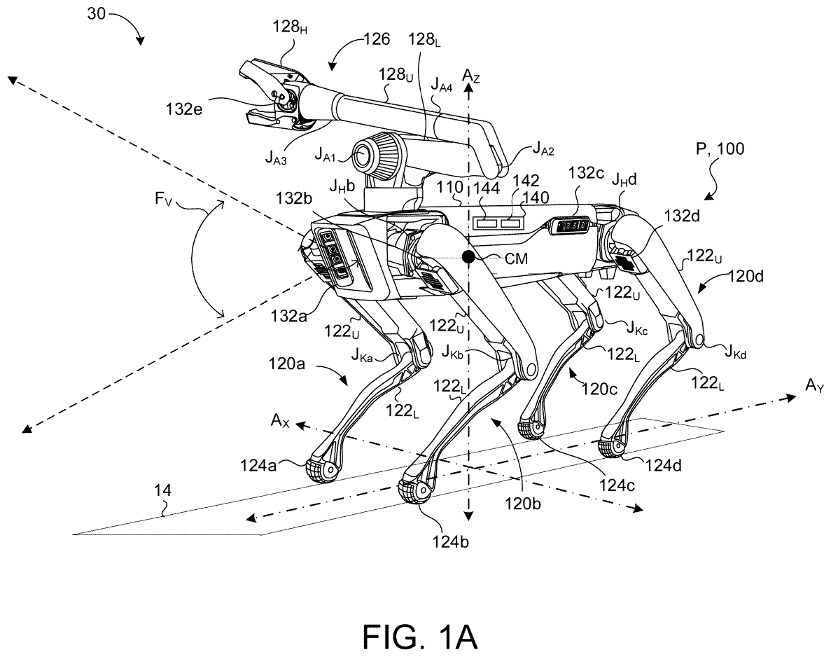

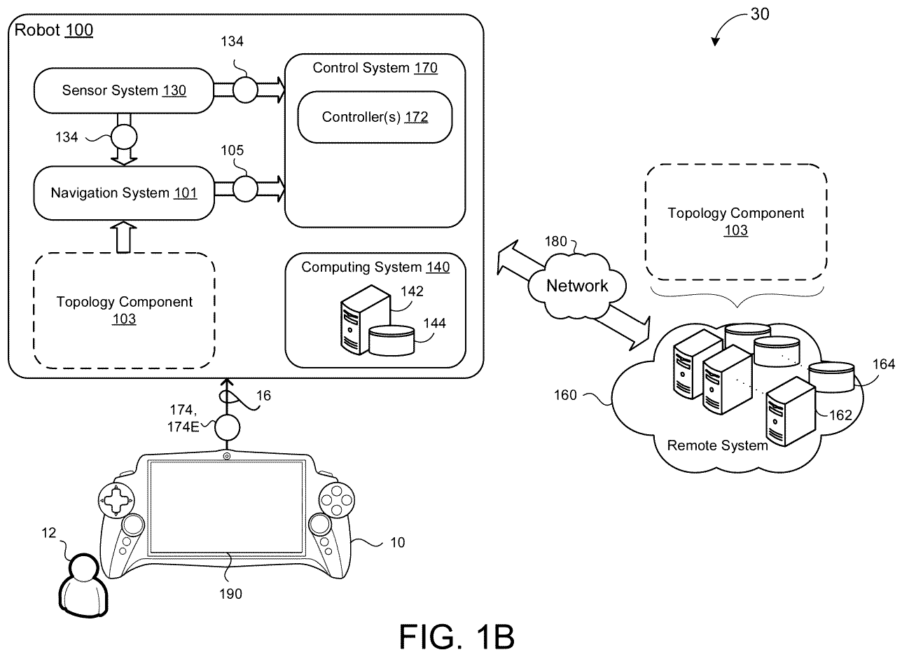

Referring to FIGS. 1A and 1B, in some implementations, a robot 100 includes a body 110 with one or more locomotion-based structures such as the first leg 120a (e.g., a stance leg), the second leg 120b, the third leg 120c, and the fourth leg 120d coupled to the body 110 that enable the robot 100 to move within an environment 30 that surrounds the robot 100. In some examples, all or a portion of the first leg 120a, the second leg 120b, the third leg 120c, and the fourth leg 120d are an articulable structure such that one or more joints J permit members of the respective leg to move. For instance, in the illustrated embodiment, all or a portion of the first leg 120a, the second leg 120b, the third leg 120c, and the fourth leg 120d include a hip joint J_{H} coupling an upper member 122_{U} of the respective leg to the body 110 and a knee joint J_{K} coupling the upper member 122_{U} of the respective leg to a lower member 122_{L} of the respective leg. Although FIG. 1A depicts a quadruped robot with four legs, the robot 100 may include any number of legs or locomotive based structures (e.g., a biped or humanoid robot with two legs, or other arrangements of one or more legs) that provide a means to traverse the terrain within the environment 30.

In order to traverse the terrain, the first leg 120a has a distal end 124a, the second leg 120b has a distal end 124b, the third leg 120c has a distal end 124c, and the fourth leg 120d has a distal end 124d. All or a portion of the distal ends may contact a surface of the terrain (e.g., a traction surface). In other words, a respective distal end of a respective leg may be the end of the respective leg used by the robot 100 to pivot, plant, or generally provide traction during movement of the robot 100. For example, the distal end of a leg may correspond to a foot of the robot 100. In some examples, though not shown, the distal end of the leg includes an ankle joint such that the distal end is articulable with respect to the lower member 122_{L} of the leg.

In the examples shown, the robot 100 includes an arm 126 that functions as a robotic manipulator. The arm 126 may move about multiple degrees of freedom in order to engage elements of the environment 30 (e.g., objects within the environment 30). In some examples, the arm 126 includes one or more members 128, where the members 128 are coupled by joints J such that the arm 126 may pivot or rotate about the joint(s) J. For instance, with more than one member 128, the arm 126 may extend or retract. To illustrate an example, FIG. 1A depicts the arm 126 with three members 128 corresponding to a lower member 128_{L}, an upper member 128_{U}, and a hand member 128_{H} (also referred to as an end-effector). Here, the lower member 128_{L} may rotate or pivot about a first arm joint J_{A1} located adjacent to the body 110 (e.g., where the arm 126 connects to the body 110 of the robot 100). The lower member 128_{L} is coupled to the upper member 128_{U} at a second arm joint J_{A2} and the upper member 128_{U} is coupled to the hand member 128_{H} at a third arm joint J_{A3}. In some examples, such as FIG. 1A, the hand member 128_{H} is a mechanical gripper that includes a moveable jaw and a fixed jaw may perform different types of grasping of elements within the environment 30. In the example shown, the hand member 128_{H} includes a fixed first jaw and a moveable second jaw that grasps objects by clamping the object between the jaws. The moveable jaw may move relative to the fixed jaw to move between an open position for the gripper and a closed position for the gripper (e.g., closed around an object). In some implementations, the arm 126 additionally includes a fourth joint J_{A4}. The fourth joint J_{A4} may be located near the coupling of the lower member 128_{L} to the upper member 128_{U} and function to allow the upper member 128_{U} to twist or rotate relative to the lower member 128_{L}. In other words, the fourth joint J_{A4} may function as a twist joint similarly to the third joint J_{A3} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates). In some implementations, the arm 126 connects to the robot 100 at a socket on the body 110 of the robot 100. In some configurations, the socket is configured as a connector such that the arm 126 attaches or detaches from the robot 100 depending on whether the arm 126 is desired for particular operations.

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (e.g., a point where the weighted relative position of the distributed mass of the robot 100 sums to zero). The robot 100 further has a pose P based on the CM relative to the vertical gravitational axis A_{Z} (e.g., the fixed reference frame with respect to gravity) to define a particular attitude or stance assumed by the robot 100. The attitude of the robot 100 can be defined by an orientation or an angular position of the robot 100 in space. Movement by the first leg 120a, the second leg 120b, the third leg 120c, and the fourth leg 120d relative to the body 110 alters the pose P of the robot 100 (e.g., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 14 where distal ends of the first leg 120a, the second leg 120b, the third leg 120c, and the fourth leg 120d of the robot 100 may generate traction to help the robot 100 move within the environment 30. Another anatomical plane of the robot 100 is the frontal plane that extends across the body 110 of the robot 100 (e.g., from a right side of the robot 100 with a first leg 120a to a left side of the robot 100 with a second leg 120b). The frontal plane spans the X-Z plane by extending in directions of the x-direction axis A_{X} and the z-direction axis A_{Z}.

In order to maneuver within the environment 30 or to perform tasks using the arm 126, the robot 100 includes a sensor system with one or more sensors. For example, FIG. 1A illustrates a first sensor 132a mounted at a head of the robot 100 (near a front portion of the robot 100 adjacent the first leg 120a and the second leg 120b), a second sensor 132b mounted near the hip J_{H}b of the second leg 120b of the robot 100, a third sensor 132c mounted on a side of the body 110 of the robot 100, a fourth sensor 132d mounted near the hip J_{H}d of the fourth leg 120d of the robot 100, and a fifth sensor 132e mounted at or near the hand member 128_{H} of the arm 126 of the robot 100. The sensors may include vision/image sensors, inertial sensors (e.g., an inertial measurement unit (IMU)), force sensors, and/or kinematic sensors. For example, the sensors may include one or more of a camera (e.g., a stereo camera), a time-of-flight (TOF) sensor, a scanning light-detection and ranging (lidar) sensor, or a scanning laser-detection and ranging (ladar) sensor. In some examples, all or a portion of the sensors may have a corresponding field(s) of view F_{V} defining a sensing range or region corresponding to the sensor. For instance, FIG. 1A depicts a field of a view F_{V} for the first sensor 132a of the robot 100. All or a portion of the sensors may be pivotable and/or rotatable such that the sensor, for example, changes the field of view F_{V} about one or more axes (e.g., an x-axis, a y-axis, or a z-axis in relation to a ground plane). In some examples, multiple sensors may be clustered together (e.g., similar to the first sensor 132a) to stitch a larger field of view F_{V} than any single sensor. With multiple sensors placed about the robot 100, the sensor system may have a 360 degree view or a nearly 360 degree view of the surroundings of the robot 100 about vertical and/or horizontal axes.

When surveying a field of view F_{V} with a sensor, the sensor system generates sensor data 134 (e.g., image data) corresponding to the field of view F_{V} (see, e.g., FIG. 1B). The sensor system may generate the field of view F_{V} with a sensor mounted on or near the body 110 of the robot 100 (e.g., the first sensor 132a, the third sensor 132c, etc.). The sensor system may additionally and/or alternatively generate the field of view F_{V} with the fifth sensor 132e mounted at or near the hand member 128_{H} of the arm 126. The one or more sensors capture the sensor data 134 that defines the three-dimensional point cloud for the area within the environment 30 of the robot 100. In some examples, the sensor data 134 is image data that corresponds to a three-dimensional volumetric point cloud generated by a three-dimensional volumetric image sensor. Additionally or alternatively, when the robot 100 is maneuvering within the environment 30, the sensor system gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg or arm 126 of the robot 100. With the sensor data 134, various systems of the robot 100 may use the sensor data 134 to define a current state of the robot 100 (e.g., of the kinematics of the robot 100) and/or a current state of the environment 30 of the robot 100. In other words, the sensor system may communicate the sensor data 134 from one or more sensors to any other system of the robot 100 in order to assist the functionality of that system.

In some implementations, the sensor system includes sensor(s) coupled to a joint J. Moreover, these sensors may couple to a motor M that operates a joint J of the robot 100. Here, these sensors may generate joint dynamics in the form of joint-based sensor data. Joint dynamics collected as the sensor data 134 (e.g., joint-based sensor data) may include joint angles (e.g., an upper member 122_{U} relative to a lower member 122_{L} or hand member 126_{H} relative to another member 128 of the arm 126 or robot 100), joint speed, joint angular velocity, joint angular acceleration, and/or forces experienced at a joint J (also referred to as joint forces). Joint-based sensor data generated by one or more sensors may be raw sensor data, data that is further processed to form different types of joint dynamics, or some combination of both. For instance, a sensor may measure joint position (or a position of member(s) coupled at a joint J) and systems of the robot 100 perform further processing to derive velocity and/or acceleration from the positional data. In other examples, a sensor may measure velocity and/or acceleration directly.

With reference to FIG. 1B, the sensor system 130 of the robot 100 gathers sensor data 134, a computing system 140 stores, processes, and/or to communicates the sensor data 134 to various systems of the robot 100 (e.g., the control system 170, a navigation system 101, a topology component 103, and/or remote controller 10). For example, the sensor system 130 may include the first sensor 132a, the second sensor 132b, the third sensor 132c, the fourth sensor 132d, the fifth sensor 132e, etc. In order to perform computing tasks related to the sensor data 134, the computing system 140 of the robot 100 includes data processing hardware 142 and memory hardware 144. The data processing hardware 142 may execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (e.g., in a single location/area on the robot 100, for example, the body 110 of the robot 100), decentralized (e.g., located at various locations about the robot 100), or a hybrid combination of both (e.g., including a majority of centralized hardware and a minority of decentralized hardware). To illustrate some differences, a decentralized computing system may allow processing to occur at an activity location (e.g., at motor that moves a joint of a leg) while a centralized computing system may allow for a central processing hub that communicates to systems located at various positions on the robot 100 (e.g., communicate to the motor that moves the joint of the leg).

Additionally or alternatively, the computing system 140 includes computing resources that are located remote from the robot 100. For instance, the computing system 140 communicates via a network 180 with a remote system 160 (e.g., a remote server or a cloud-based environment). Much like the computing system 140, the remote system 160 includes remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 may utilize the remote data processing hardware 162 and the remote memory hardware 164 as extensions of the data processing hardware 142 and the memory hardware 144 such that resources of the computing system 140 reside on resources of the remote system 160. In some examples, the topology component 103 is executed on the data processing hardware 142 local to the robot, while in other examples, the topology component 103 is executed on the remote data processing hardware 162 that is remote from the robot 100.

In some implementations, as shown in FIG. 1B, the robot 100 includes a control system 170. The control system 170 may communicate with systems of the robot 100, such as the sensor system 130, the navigation system 101, and/or the topology component 103. For example, the navigation system 101 may provide a step plan 105 to the control system 170. The control system 170 may perform operations and other functions using hardware such as the computing system 140. The control system 170 includes at least one controller 172 that may control the robot 100. For example, the at least one controller 172 controls movement of the robot 100 to traverse the environment 30 based on input or feedback from the systems of the robot 100 (e.g., the sensor system 130 and/or the control system 170). In additional examples, the at least one controller 172 controls movement between poses and/or behaviors of the robot 100. The at least one controller 172 may be responsible for controlling movement of the arm 126 of the robot 100 in order for the arm 126 to perform various tasks using the hand member 128_{H}. For instance, the at least one controller 172 controls the hand member 128_{H} (e.g., a gripper) to manipulate an object or element in the environment 30. For example, the at least one controller 172 actuates the movable jaw in a direction towards the fixed jaw to close the gripper. In other examples, the at least one controller 172 actuates the movable jaw in a direction away from the fixed jaw to close the gripper.

The at least one controller 172 of the control system 170 may control the robot 100 by controlling movement about one or more joints J of the robot 100. In some configurations, the at least one controller 172 is software or firmware with programming logic that controls at least one joint J or a motor M which operates, or is coupled to, a joint J. A software application (a software resource) may refer to computer software that causes a computing device to perform a task. In some examples, a software application may be referred to as an “application,” an “app,” or a “program.” For instance, the at least one controller 172 controls an amount of force that is applied to a joint J (e.g., torque at a joint J). As at least one controller 172 may be programmable, the number of joints J that the at least one controller 172 controls may be scalable and/or customizable for a particular control purpose. The at least one controller 172 may control a single joint J (e.g., control a torque at a single joint J), multiple joints J, or actuation of one or more members 128 (e.g., actuation of the hand member 128_{H}) of the robot 100. By controlling one or more joints J, actuators or motors M, the at least one controller 172 may coordinate movement for all different parts of the robot 100 (e.g., the body 110, one or more legs, the arm 126). For example, to perform a behavior with some movements, the at least one controller 172 may control movement of multiple parts of the robot 100 such as, for example, the first leg 120a and the second leg 120b, the first leg 120a, the second leg 120b, the third leg 120c, and the fourth leg 120d, or the first leg 120a and the second leg 120b combined with the arm 126. In some examples, the at least one controller 172 may be configured as an object-based controller that is set up to perform a particular behavior or set of behaviors for interacting with an interactable object.

With continued reference to FIG. 1B, an operator 12 (also referred to herein as a user or a client) may interact with the robot 100 via the remote controller 10 that communicates with the robot 100 to perform actions. For example, the operator 12 transmits commands 174 to the robot 100 (executed via the control system 170) via a wireless communication network 16. Additionally, the robot 100 may communicate with the remote controller 10 to display an image on a user interface 190 of the remote controller 10. For example, the user interface 190 may display the image that corresponds to three-dimensional field of view F_{V} of the one or more sensors of the robot 100. The image displayed on the user interface 190 of the remote controller 10 is a two-dimensional image that corresponds to the three-dimensional point cloud of sensor data 134 (e.g., field of view F_{V}) for the area within the environment 30 of the robot 100. That is, the image displayed on the user interface 190 may be a two-dimensional image representation that corresponds to the three-dimensional field of view F_{V} of the one or more sensors.

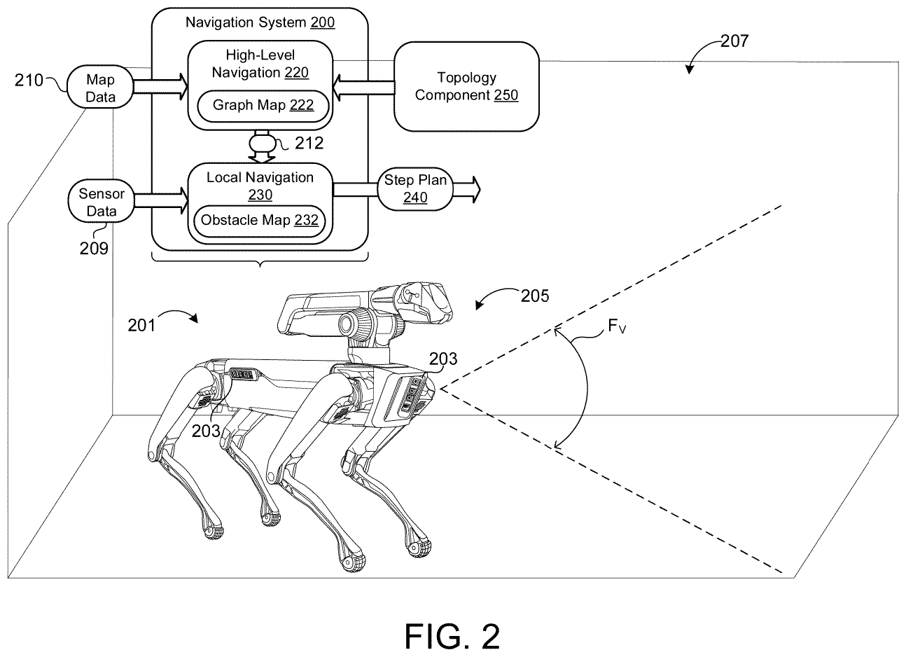

Referring now to FIG. 2, the robot 201 (e.g., the data processing hardware 142 as discussed herein with reference to FIGS. 1A and 1B) executes a navigation system 200 for enabling the robot 201 to navigate the environment 207. The sensor system 205 includes one or more sensors 203 (e.g., image sensors, lidar sensors, ladar sensors, etc.) that can each capture sensor data 209 of the environment 207 surrounding the robot 201 within the field of view F_{V}. For example, the one or more sensors 203 may be one or more cameras. The sensor system 205 may move the field of view F_{V} by adjusting an angle of view or by panning and/or tilting (either independently or via the robot 201) one or more sensors 203 to move the field of view F_{V} in any direction. In some implementations, the sensor system 205 includes a plurality of sensors (e.g., multiple cameras) such that the sensor system 205 captures a generally 360-degree field of view around the robot 201. The navigation system 200 may include and/or may be similar to the navigation system 101 discussed herein with reference to FIG. 1B, the topology component 250 may include and/or may be similar to the topology component 103 discussed herein with reference to FIG. 1B, the step plan 240 may include and/or may be similar to the step plan 105 discussed herein with reference to FIG. 1B, the robot 201 may include and/or may be similar to the robot 100 discussed herein with reference to FIGS. 1A and 1B, the one or more sensors 203 may include and/or may be similar to the one or more sensors discussed herein with reference to FIG. 1A, the sensor system 205 may include and/or may be similar to the sensor system 130 discussed herein with reference to FIG. 1B, the environment 207 may include and/or may be similar to the environment 30 discussed herein with reference to FIGS. 1A and 1B, and/or the sensor data 209 may include and/or may be similar to the sensor data 134 discussed herein with reference to FIG. 1B.

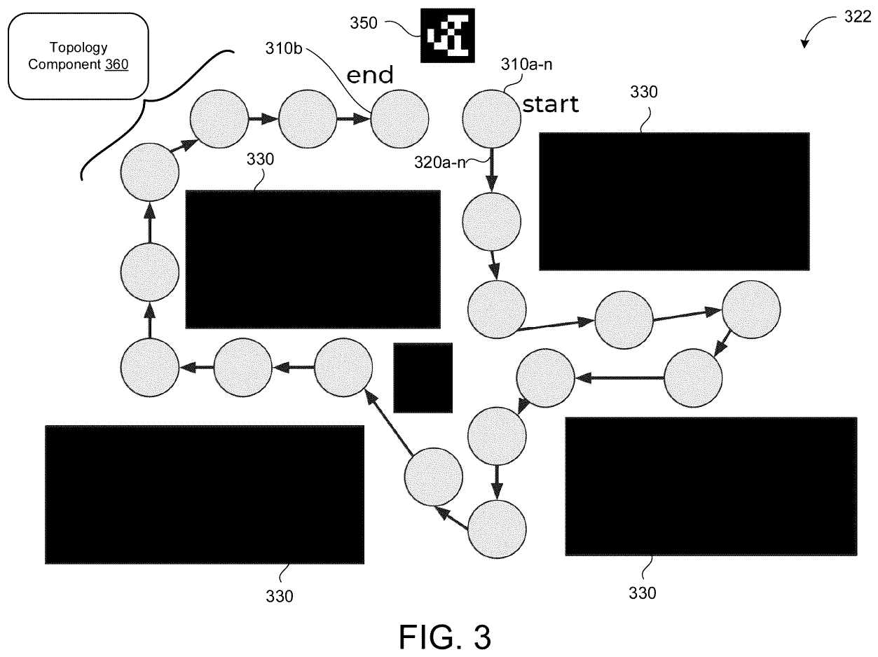

In the example of FIG. 2, the navigation system 200 includes a high-level navigation module 220 that receives map data 210 (e.g., high-level navigation data representative of locations of static obstacles in an area the robot 201 is to navigate). In some cases, the map data 210 includes a graph map 222. In other cases, the high-level navigation module 220 generates the graph map 222. The graph map 222 may include a topological map of a given area the robot 201 is to traverse. The high-level navigation module 220 can obtain (e.g., from the remote system 160 or the remote controller 10 or the topology component 250) and/or generate a series of route waypoints (as shown in FIG. 3) on the graph map 222 for a navigation route 212 that plots a path around large and/or static obstacles from a start location (e.g., the current location of the robot 201) to a destination. Route edges may connect corresponding pairs of adjacent route waypoints. In some examples, the route edges record geometric transforms between route waypoints based on odometry data (e.g., odometry data from motion sensors or image sensors to determine a change in the robot's position over time). The route waypoints and the route edges may be representative of the navigation route 212 for the robot 201 to follow from a start location to a destination location.

As discussed in more detail herein, in some examples, the high-level navigation module 220 receives the map data 210, the graph map 222, and/or an optimized graph map from a topology component 250. The topology component 250, in some examples, is part of the navigation system 200 and executed locally at or remote from the robot 201.

In some implementations, the high-level navigation module 220 produces the navigation route 212 over a greater than 10-meter scale (e.g., the navigation route 212 may include distances greater than 10 meters from the robot 201). The scale for the high-level navigation module 220 can be set based on the robot 201 design and/or the desired application, and is typically larger than the range of the one or more sensors 203. The navigation system 200 also includes a local navigation module 230 that can receive the navigation route 212 and the sensor data 209 (e.g., image data) from the sensor system 205. The local navigation module 230, using the sensor data 209, can generate an obstacle map 232. The obstacle map 232 may be a robot-centered map that maps obstacles (static and/or dynamic obstacles) in the vicinity (e.g., within a threshold distance) of the robot 201 based on the sensor data 209. For example, while the graph map 222 may include information relating to the locations of walls of a hallway, the obstacle map 232 (populated by the sensor data 209 as the robot 201 traverses the environment 207) may include information regarding a stack of boxes placed in the hallway that were not present during the original recording. The size of the obstacle map 232 may be dependent upon both the operational range of the one or more sensors 203 and the available computational resources.

The local navigation module 230 can generate a step plan 240 (e.g., using an A* search algorithm) that plots all or a portion of the individual steps (or other movements) of the robot 201 to navigate from the current location of the robot 201 to the next route waypoint along the navigation route 212. Using the step plan 240, the robot 201 can maneuver through the environment 207. The local navigation module 230 may obtain a path for the robot 201 to the next route waypoint using an obstacle grid map based on the sensor data 209. In some examples, the local navigation module 230 operates on a range correlated with the operational range of the one or more sensors 203 (e.g., four meters) that is generally less than the scale of high-level navigation module 220.

Referring now to FIG. 3, in some examples, the topology component 360 obtains the graph map 322 (e.g., a topological map) of an environment (e.g., the environment 30 as discussed herein with reference to FIGS. 1A and 1B). For example, the topology component 360 receives the graph map 322 from a navigation system (e.g., the high-level navigation module 220 of the navigation system 200 as discussed herein with reference to FIG. 2) or generates the graph map 322 from map data (e.g., map data 210 as discussed herein with reference to FIG. 2) and/or sensor data (e.g., sensor data 134 as discussed herein with reference to FIG. 1B). The graph map 322 may be similar to and/or may include the graph map 222 discussed herein with reference to FIG. 2. The topology component 360 may be similar to and/or may include the topology component 250 discussed herein with reference to FIG. 2. The graph map 322 includes a series of route waypoints 310a-n and a series of route edges 320a-n. Each route edge in the series of route edges 320a-n topologically connects a corresponding pair of adjacent route waypoints in the series of route waypoints 310a-n. Each route edge represents a traversable route for a robot (e.g., the robot 100 as discussed herein with reference to FIGS. 1A and 1B) through an environment of the robot. The map may also include information representing one or more obstacles 330 that mark boundaries where the robot may be unable to traverse (e.g., walls and static objects). In some cases, the graph map 322 may not include information regarding the spatial relationship between route waypoints. The robot may record the series of route waypoints 310a-n and the series of route edges 320a-n using odometry data captured by the robot as the robot navigates the environment. The robot may record sensor data at all or a portion of the route waypoints such that all or a portion of the route waypoints are associated with a respective set of sensor data captured by the robot (e.g., a point cloud). In some implementations, the graph map 322 includes information related to one or more fiducial markers 350. The one or more fiducial markers 350 may correspond to an object that is placed within the field of sensing of the robot that the robot may use as a fixed point of reference. The one or more fiducial markers 350 may be any object that the robot is capable of readily recognizing, such as a fixed or stationary object of the environment or an object with a recognizable pattern. For example, a fiducial marker of the one or more fiducial markers 350 may include a bar code, QR-code, or other pattern, symbol, and/or shape for the robot to recognize.

In some cases, the robot may navigate along valid route edges and may not navigate along between route waypoints that are not linked via a valid route edge. Therefore, some route waypoints may be located (e.g., metrically, geographically, physically, etc.) within a threshold distance (e.g., five meters, three meters, etc.) without the graph map 322 reflecting a route edge between the route waypoints. In the example of FIG. 3, the route waypoint 310a and the route waypoint 310b are within a threshold distance (e.g., a threshold distance in physical space or reality), Euclidean space, Cartesian space, and/or metric space, but the robot, when navigating from the route waypoint 310a to the route waypoint 310b, may navigate the all or a portion of the series of route edges 320a-n due to the lack of a route edge directly connecting the route waypoints 310a, 310b. Therefore, the robot may determine, based on the graph map 322, that there is no direct traversable path between the route waypoints 310a, 310b. The graph map 322 may represent the route waypoints 310 in global (e.g., absolute positions) and/or local positions where positions of the route waypoints are represented in relation to one or more other route waypoints. The route waypoints may be assigned Cartesian or metric coordinates, such as 3D coordinates (x, y, z translation) or 6D coordinates (x, y, z translation and rotation).

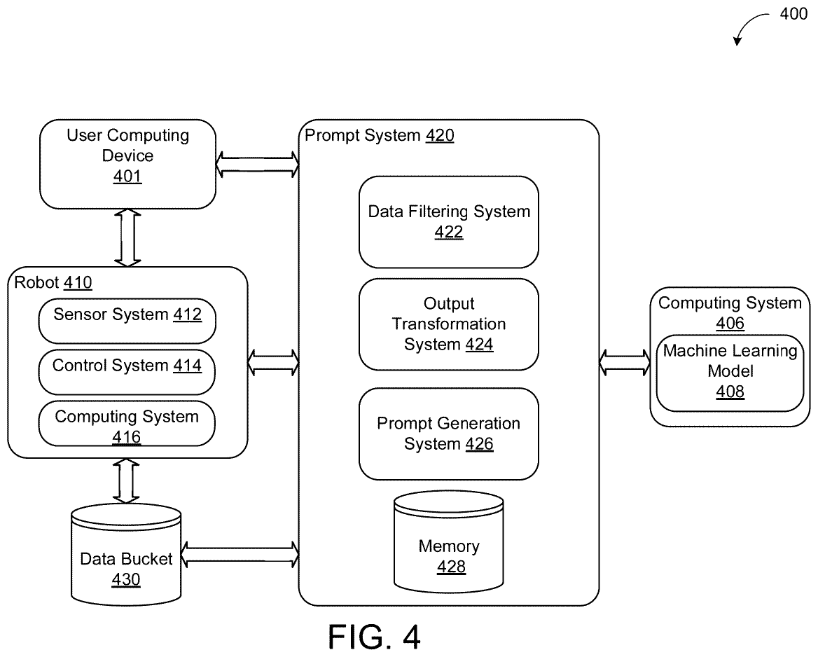

Referring now to FIG. 4, an environment 400 may include a robot 410, a user computing device 401, a prompt system 420, a computing system 406, and a data bucket 430. The robot 410, the user computing device 401, and the prompt system 420 may each be in communication (e.g., via a network) with one another (e.g., the user computing device 401 may be in communication with the robot 410). In some cases, the robot 410 may be in communication with multiple user computing devices and/or multiple prompt systems. For example, the robot 410 may be in communication with a plurality of user computing devices associated with a plurality of users. In some cases, a plurality of robots may be in communication with the user computing device 401 and/or the prompt system 420.

The robot 410 may write log data to a data bucket 430 and the prompt system 420 may read the log data from the data bucket 430. In some cases, a plurality of robots may write log data to the data bucket 430. The prompt system 420 may be in communication with a computing system 406 that may implement a machine learning model 408. For example, the computing system 406 may be a backend server, a backend system, etc. that may provide an output in response to a prompt. Further, the machine learning model 408 may be Chat Generative Pre-trained Transformer (“ChatGPT”), Pathways Language Model (“PaLM”), Large Language Model Meta Artificial Intelligence (“LLaMA”), etc.

As discussed herein, the computing system 406 may be a computer vision system and the computing system 406 may implement a machine learning model 408 (e.g., a visual question answering model). The machine learning model 408 may be trained to obtain an input (e.g., image data and text data) and provide an output based on the input. In some cases, the machine learning model 408 may be trained to obtain an image and a request (e.g., a question associated with the image) and provide an output (e.g., a natural language output) which includes a response to the request (e.g., an answer to the question).

As discussed herein with reference to FIG. 1B, the robot 410 may include a sensor system 412, a control system 414, and a computing system 416. For example, where the environment 400 includes a plurality of robots, all or a portion of the plurality of robots may include a respective sensor system, a respective control system, and/or a respective computing system. The robot 410 may include and/or may be similar to the robot 100 discussed herein with reference to FIGS. 1A and 1B.

The sensor system 412 can gather sensor data. The sensor system 412 may include a plurality of sensors (e.g., image sensors) of the robot 410 and the sensor system 412 may gather the sensor data via the plurality of sensors. The sensor system 412 may include and/or may be similar to the sensor system 130 discussed herein with reference to FIG. 1B. The sensor system 412 may provide the sensor data to other systems of the robot 410 (e.g., the control system 414).

In one example, the sensor system 412 may include a plurality of sensors (e.g., five sensors) distributed on the robot 410. For example, the sensor system 412 may include a plurality of sensors distributed across the body, one or more legs, arm, etc. of the robot 410. The plurality of sensors may include at least two different types of sensors. For example, the plurality of sensors may include lidar sensors, image sensors, ladar sensors, audio sensors, etc. and the sensor data may include lidar sensor data, image (e.g., camera) sensor data, ladar sensor data, audio data, etc.

In some cases, the sensor data may include three-dimensional point cloud data. The sensor system 412 (or a separate system) may use the three-dimensional point cloud data to detect and track features within a three-dimensional coordinate system. For example, the sensor system 412 may use the three-dimensional point cloud data to detect and track movers within the environment.

The computing system 416 may include data processing hardware (e.g., a data processor, a hardware processor, etc.) and memory hardware. The memory hardware may store instructions and the data processing hardware may execute the instructions which may cause the data processing hardware to perform one or more operations. The computing system 416 may include and/or may be similar to the computing system 140 discussed herein with reference to FIGS. 1A and 1B.

The control system 414 may include a controller (e.g., similar to the at least one controller 172 discussed herein). The control system 414 may include and/or may be similar to the control system 170 discussed herein with reference to FIG. 1B.

As discussed herein, the robot 410 may be in communication with a data bucket 430 to store data (e.g., log data). For example, the data bucket 430 may be a portion of memory (e.g., a reserved portion of data storage, virtual storage, cloud storage, etc.) that can store log data corresponding to one or more logs that are grouped according to a particular parameter. The data bucket 430 may correspond to the particular parameter, as discussed herein, and may store data tagged with the particular parameter.

The prompt system 420 may include a computing system to generate a prompt for the machine learning model 408. The prompt system 420 may include a data filtering system 422, an output transformation system 424, a prompt generation system 426, and memory 428.

The sensor system 412 of the robot 410 may obtain sensor data (e.g., via one or more sensors of the sensor system 412). In some cases, the sensor system 412 may receive instructions from the user computing device 401 (e.g., associated with an operator of the robot 410) and may obtain the sensor data based on the instructions. For example, the user computing device 401 may provide instructions that instruct the robot 410 to traverse an environment and obtain sensor data. In response to the instructions, the robot 410 may initiate traversal of the environment and obtaining of the sensor data.

Based on obtaining the sensor data, the sensor system 412 may provide the sensor data to the computing system 416 of the robot. The computing system 416 may tag the sensor data. For example, the computing system 416 may generate and/or associate parameter data with the sensor data. The parameter data may include and/or may indicate one or more parameters. For example, the one or more parameters may be tags, annotations, labels, etc. The one or more parameters may indicate an event, an action, an object, an obstacle, a structure, an entity, a time, particular data, etc. associated with a robot. For example, the one or more parameters may indicate that the corresponding sensor data is associated with a slip of the robot 410, a fall of the robot 410, a docking of the robot 410, a contact by the robot 410 with a ground surface, an operation of the robot 410 at a particular time (e.g., at night), an operation of the robot 410 to open a door, an operation of a hand member of the robot 410 to grasp an object, a particular entity within a particular radius of the robot 410, etc.

For example, the computing system 416 may implement a machine learning model trained to output parameter data based on the sensor data and may obtain an output indicating parameter data based on providing the sensor data to the machine learning model. In another example, the computing system 416 may generate the parameter data based on filtering the sensor data (e.g., the computing system 416 may filter the parameter data from the sensor data). In some cases, the computing system 416 may provide the sensor data to a separate computing system to tag the data (e.g., the separate computing system may implement the machine learning model). For example, a remote computing system may implement the machine learning model and the computing system 416 may provide the sensor data to and obtain an output from the remote computing system. In some cases, the machine learning model may be less resource intensive and/or not as powerful as compared to the machine learning model 408.

The computing system 416 may generate log data based on the parameter data and the sensor data. For example, the computing system 416 may generate the log data by combining (e.g., appending, joining, etc.) the parameter data and the sensor data. In some cases, the log data may include the sensor data and may not include parameter data. For example, the computing system 416 may not separately generate parameter data and may store the sensor data as log data.

The computing system 416 may store the log data in the data bucket 430. In some cases, the computing system 416 may provide the log data to a second system (e.g., a remote computing system) and the second system may store the log data in the data bucket 430.

To store the log data in the data bucket 430, the computing system 416 may identify one or more parameters associated with the data bucket 430. The data bucket 430 may be associated with one or more parameters indicating that data stored in the data bucket is to be associated with the one or more parameters. In some cases, to identify the one or more parameters associated with the data bucket 430, the computing system 416 may obtain bucket data indicative of the one or more parameters associated with the data bucket 430.

In some cases, the computing system 416 may store a portion of the sensor data in the data bucket 430. For example, the computing system 416 may determine a first portion of the sensor data corresponds to (e.g., is associated with parameter data that includes) the one or more parameters of the data bucket 430 and a second portion of the sensor data does not correspond to the one or more parameters of the data bucket 430. The computing system 416 may store the first portion of the sensor data in the data bucket 430 and may not store the second portion of the sensor data in the data bucket 430 (e.g., the computing system 416 may store the second portion of the sensor data in a second data bucket).

The computing system 416 may periodically or aperiodically tag sensor data (e.g., generate parameter data for the sensor data) to obtain log data and store the log data in the data bucket 430. For example, the computing system 416 may tag the sensor data in response to obtaining the sensor data from the sensor system 412.

As the amount of sensor data (and corresponding log data) may be large (e.g., terabytes of data), the environment 400 may include a prompt system 420 to dynamically generate a prompt based on the log data such that by providing the prompt to a computing system and obtaining an output based on the prompt, the prompt system 420 can reduce the amount of data (e.g., for monitoring).

As discussed herein, the prompt system 420 can generate a prompt based on log data and an input (e.g., a textual input) from the user computing device 401. To generate the prompt, the prompt system 420 may obtain the input from the user computing device 401 and may obtain the log data from the data bucket 430. In some cases, the prompt system 420 may store the input and/or the log data in memory 428 (e.g., local memory of the prompt system 420).

The prompt system 420 may cause display of a user interface via the user computing device 401 and may enable the user computing device 401 to provide the input via the user interface. For example, the user interface may include a section to provide an input. Based on an interaction by the user computing device 401 with the user interface, the prompt system 420 may obtain the input from the user computing device 401. In some cases, the input may correspond to a selection of one or more selectable identifiers (e.g., selection of a particular request, selection of a particular robot, selection of a particular time, etc.). In some cases, the input may correspond to a dynamic input (e.g., a user may dynamically provide a textual input).

The input may include and/or indicate one or more requests (e.g., questions). The one or more requests may include one or more open ended questions and/or one or more close ended questions (e.g., multiple choice questions). For example, the input may include a request to identify whether the robot 410 slipped, a request to identify what the robot 410 slipped on if the robot slipped, a request to identify whether the robot 410 fell, a request to generate a pictorial representation of an environment of the robot 410, a request to sort (e.g., visually sort) and/or rank (e.g., visually rank) objects, entities, obstacles, or structures within the environment, etc. In another example, the input may include a request to identify log data where one or more parameters of the log data are erroneous (e.g., do not match the parameters of the parameter data assigned to the log data). The input (e.g., the one or more requests) may further include and/or indicate one or more parameters. For example, the one or more requests may include a request to generate a prompt based on log data associated with a particular parameter (e.g., indicating that the robot 410 fell).

The prompt system 420 may obtain log data from the data bucket 430 (e.g., in response to obtaining the input from the user computing device 401). The prompt system 420 may identify one or more data buckets from which to obtain the log data based on the input and may obtain the log data from the one or more data buckets. To identify the one or more data buckets, the prompt system 420 may identify one or more parameters defined by the input and identify one or more data buckets that correspond to the one or more parameters. For example, the input may define a request to identify whether the robot 410 fell for log data associated with a particular parameter indicating that the robot 410 did fall and the prompt system 420 may identify a data bucket associated with the particular parameter.

In the example of FIG. 4, the prompt system 420 may identify the data bucket 430 based on the input from the user computing device 401. Based on identifying the data bucket 430, the prompt system 420 may obtain log data from the data bucket 430. For example, the prompt system 420 may obtain all or a portion of the log data stored in the data bucket 430.

While the log data stored in the data bucket 430 may be filtered (e.g., according to the parameter data associated with the log data), the amount of log data may be large. To reduce the amount of the log data, the prompt system 420 may include a data filtering system 422. The prompt system 420 may obtain the log data from the data bucket 430 (e.g., based on the input) and may provide the log data to the data filtering system 422.

The data filtering system 422 may filter the log data to obtain filtered log data. For example, the data filtering system 422 may filter the log data such that the filtered log data includes a first portion of the log data and excludes a second portion of the log data. In some cases, to filter the log data (e.g., image data), the data filtering system 422 may remove one or more images from the log data such that the filtered log data includes a first portion of the images of the log data and excludes a second portion of the images of the log data. In some cases, to filter the log data, the data filtering system 422 may remove a first portion of an image (e.g., an outer portion of the image, a particular object, entity, obstacle, or structure within the image, etc.) such that the filtered log data includes a second portion of the image but does not include the first portion of the image. In some cases, to filter the log data, the data filtering system 422 may blur (e.g., obscure) a portion of an image of the log data (e.g., an outer portion of the image, a particular object, entity, obstacle, or structure within the image, etc.) such that the filtered log data includes the blurred image.

The data filtering system 422 may filter the log data to identify a particular portion of the log data (e.g., log data associated with a particular time period, log data within a particular proximity of an event, etc.). For example, the data filtering system 422 may filter log data associated with a fall of the robot 410 to obtain filtered log data that includes log data captured within a particular temporal proximity of the fall of the robot 410. In some cases, the data filtering system 422 may filter the log data in a parameter specific manner. For example, the data filtering system 422 may filter log data associated with a first parameter (e.g., indicating a fall of the robot 410) to include comparatively less log data as compared to log data associated with a second parameter (e.g., indicating a presence of an entity within a particular proximity of the robot 410).

The data filtering system 422 may provide the filtered log data to the prompt generation system 426. The prompt generation system 426 may obtain the filtered log data from the data filtering system 422 and the input (e.g., from the user computing device 401). The prompt generation system 426 may generate (e.g., dynamically generate) a prompt based on the filtered log data and the input. The prompt may include log data (e.g., image data) and text data (e.g., natural language data). The text data may include a request based on the input. For example, the request may be a request to identify whether the robot 410 performed a particular action based on the log data (e.g., whether the robot fell), a request to compare two or more images from the log data (e.g., compare characteristics of one or more entities, obstacles, objects, or structures indicated by the two or more images), a request to sort and/or rank two or more images, etc.

In some cases, the prompt generation system 426 may generate a visual prompt (e.g., the prompt may include image data from the log data that is combined with the text data). In some cases, the prompt generation system 426 may generate a prompt that includes separate visual and textual components. For example, the prompt generation system 426 may append text data (e.g., based on the input) to the log data to generate the prompt (e.g., may embed text data within image data of the log data). In another example, the prompt generation system 426 may annotate the log data with the text data to generate the prompt. In another example, the prompt generation system 426 may include the log data and the text data within the prompt (e.g., the prompt generation system 426 may combine the log data and the text data within the prompt).

In some cases, to generate the prompt, the prompt generation system 426 may identify first sensor data of the log data (e.g., image data) and second sensor data of the log data (e.g., non-image data). For example, the second sensor data may include pressure data, acceleration data, battery data (e.g., voltage data), speed data, position data, orientation data, pose data, tilt data, time data (e.g., a timestamp), temperature data, etc. The prompt generation system 426 may generate text data corresponding to all or a portion of the non-image data. For example, the text data may include one or more fields and one or more fields values based on the all or a portion of the non-image data. In some cases, the prompt generation system 426 may append and/or annotate the image data with the text data corresponding to the all or a portion of the non-image data. In some cases, the prompt generation system 426 may generate a prompt that includes the image data and the text data corresponding to the all or a portion of the non-image data.

As discussed herein, the prompt generation system 426 may perform prompt engineering to generate the prompt. The prompt generation system 426 may perform prompt engineering such that the generated prompt is customized (e.g., specific) to the robot 410. For example, the prompt generation system 426 may include context data (e.g., text data) within the prompt indicating a context of the prompt (and the log data within the prompt) (e.g., the prompt is associated with the robot, the prompt is associated with a mobile robot, the prompt is associated with a legged robot, the prompt is associated with a robot with a particular number of sensors and/or legs, sensor data of the log data is captured via one or more sensors of a legged robot, the sensors and/or legs of the robot have a particular placement, orientation, pose, movement, etc.).

By customizing the generated prompt to the robot 410, the prompt generation system 426 can generate a prompt that accounts for robot specific characteristics (e.g., that the sensor data may indicate one or more legs of the robot 410, that the sensor data may indicate a ground surface beneath a legged robot, that the sensor data may indicate a docking of the robot 410, that the sensor data may indicate other robots within an environment of the robot 410, that the sensor data may indicate a particular operation such as descent of one or more stairs backwards, etc.).

In some cases, the prompt generation system 426 can dynamically identify context data to add to the prompt. The prompt generation system 426 can identify context data based on the parameters assigned to the log data (e.g., indicating that the log data is associated with a fall, a flip over, a trip, a dock, etc.). For example, for a prompt based on log data assigned a parameter corresponding to a failure to dock by the robot, the prompt generation system 426 can identify and add context data to the prompt indicating how the robot properly docks, what the dock looks like, a component of the robot used to dock, etc. In another example, for a prompt based on log data assigned a parameter corresponding to a fall by the robot, the prompt generation system 426 can identify and add context data to the prompt indicating a placement of legs of the robot, a particular sensor is to be oriented towards a ground surface during operation of the robot, etc. and may exclude context data associated with a dock of the robot. In another example, for a prompt based on log data assigned a parameter corresponding to identification of an object, the prompt generation system 426 can identify and add context data to the prompt indicating characteristics of a dock, characteristics of another robot, etc.

The prompt system 420 may provide the generated prompt (e.g., generated by the prompt generation system 426) to the computing system 406. For example, the prompt system 420 may provide the generated prompt via a network.

Based on the prompt system 420 providing the generated prompt to the computing system 406, the computing system 406 may provide the generated prompt to the machine learning model 408. The computing system 406 may obtain an output from the machine learning model 408 based on providing the generated prompt to the machine learning model 408 and may provide the output to the prompt system 420. The output may include a response to the request (e.g., an answer to a question).

In some cases, the prompt system 420 may generate a plurality of prompts and may provide the plurality of prompts to the computing system 406. For example, the plurality of prompts may include a first prompt to compare a first image and a second image, a second prompt to compare a third image and a fourth image, etc. In another example, the plurality of prompts may include a prompt to compare a first image, a second image, a third image, a fourth image, etc.

In some cases, the prompt system 420 may iteratively generate and/or iteratively provide the one or more prompts (e.g., based on the output provided by the machine learning model 408). For example, the prompt system 420 may generate and provide to the computing system 406 a first prompt to compare a first image and a second image and a second prompt to compare a third image and a fourth image. The prompt system 420 may receive an output from the computing system 406 indicating the comparison of the first image and the second image (e.g., that a value associated with the first image is greater than, less than, or equal to a value associated with the second image) and the comparison of the third image and the fourth image (e.g., that a value associated with the third image is greater than, less than, or equal to a value associated with the fourth image). The prompt system 420 may generate a third prompt to compare one of the first image or the second image (e.g., based on the comparison of the first image and the second image indicating that the value associated with the first image is greater than, less than, or equal to a value associated with the second image) to one of the third image or the fourth image (e.g., based on the comparison of the third image and the fourth image indicating that the value associated with the third image is greater than, less than, or equal to a value associated with the fourth image). The prompt system 420 may provide the third prompt to the computing system 406 and obtain a corresponding output.

The prompt system 420 may obtain the output(s) from the computing system 406. The prompt system 420 may provide the output(s) to the output transformation system 424 and the output transformation system 424 may transform the output(s). For example, the output transformation system 424 may transform the output(s) based on the input from the user computing device 401 (e.g., the input may include a request to generate a pictorial representation of the environment, generate a graphical representation of the output, provide image data, provide a text data response, flag data for review, generate an alert, etc.). The output transformation system 424 may transform the output to generate a transformed output that may include a pictorial representation of the environment, a graphical representation of the output, image data, a text data response, a flag, an alert, etc.

In some cases, the prompt system 420 may store the output(s) and/or the transformed output in a database (e.g., in memory 428). For example, the prompt system 420 may store the output(s) and/or the transformed output and provide an indication indicating that the output(s) and/or the transformed output are stored and/or an identifier of a location where the output(s) and/or the transformed output are stored.

In some cases, the prompt system 420 may provide the output(s) and/or the transformed output to the user computing device 401 or a separate user computing device. For example, the prompt system 420 may cause display of the output(s) and/or the transformed output via a user interface of the user computing device 401. The prompt system 420 may provide the output(s) and/or the transformed output for review, annotation, etc. of corresponding log data.

In some cases, the prompt system 420 may provide the output(s) and/or the transformed output to the robot 410. For example, the prompt system 420 may provide the output(s) and/or the transformed output to the robot 410 and may train a machine learning model of the robot 410 (e.g., the machine learning model of the robot 410 for generation of the parameter data associated with the log data) based on the output(s) and/or the transformed output. By training the machine learning model in such a manner, the prompt system 420 may improve the effectiveness of and accuracy of the output of the machine learning model. In some cases, the prompt system 420 may adjust how the machine learning model of the robot 410 outputs parameters, what parameters the robot 410 outputs, etc. based on the output(s) and/or the transformed output.

In some cases, the prompt system 420 may provide the output(s) and/or the transformed output to the data bucket 430. For example, the prompt system 420 may store the output(s) and/or the transformed output in the data bucket 430. In some cases, the prompt system 420 may replace the data stored in the data bucket 430 with the output(s) and/or the transformed output. By replacing the data stored in the data bucket 430 in such a manner, the prompt system 420 can greatly reduce the amount of data stored in the data bucket 430.

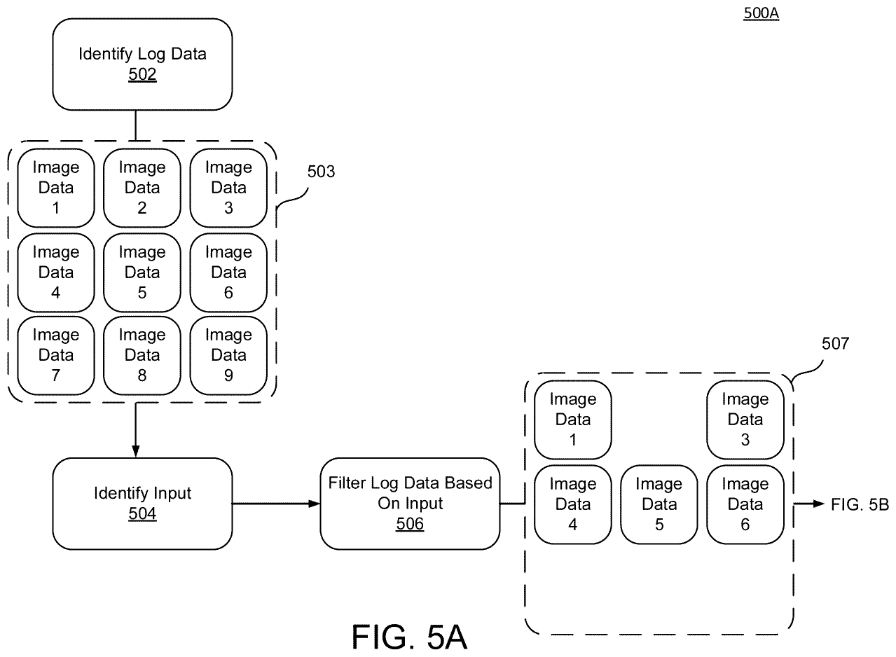

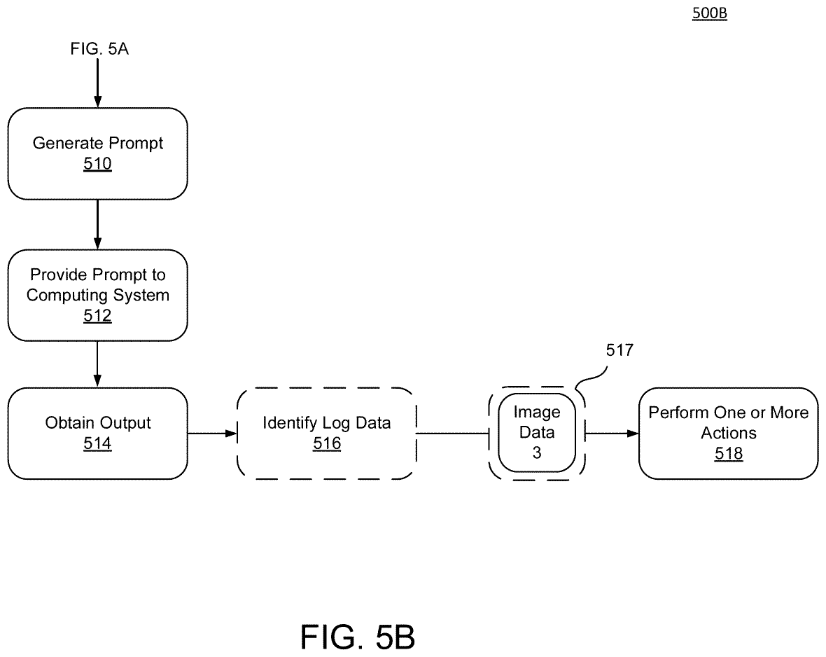

FIG. 5A and FIG. 5B are operation diagrams illustrating a data flow for dynamically generating a prompt for a machine learning model based on log data and performing an action based on the output of the machine learning model. Any component of the robot 410 can facilitate the data flow, as discussed herein. In some embodiments, a different component can facilitate the data flow. In the example of FIG. 5A and FIG. 5B, the prompt system (e.g., the prompt system 420) facilitates the data flow.

FIG. 5A is an operation diagram 500A for filtering log data based on an input. The operation diagram 500A may correspond to a first portion to a first portion of a step to perform one or more actions based on log data and the operation diagram 500B, as discussed herein with reference to FIG. 5B, may correspond to a second, subsequent portion of the step. In some examples, the first and second portions of the step may be separated by one or more intermediate steps.

At step 502, the prompt system 420 identifies log data 503. For example, the log data 503 may include sensor data obtained via one or more sensors of a robot. In some cases, the prompt system 420 may obtain the log data 503 directly from the one or more sensors. In some cases, the prompt system 420 may obtain the log data from one or more data buckets (e.g., as stored by the robot).

The log data 503 may be first filtered and/or grouped log data (e.g., may include filtered and/or grouped sensor data of the robot). For example, the robot may obtain sensor data via the one or more sensors, generate parameter data (e.g., indicating parameters) associated with the sensor data, filter and/or group the sensor data based on the parameter data to obtain filtered and/or grouped sensor data, generate log data (e.g., first filtered and/or grouped log data) based on the filtered and/or grouped sensor data, and may store the log data 503 in a data bucket (e.g., associated with a parameter that corresponds to a parameter of the filtered and/or grouped sensor data).

In the example of FIG. 5A, the log data 503 includes image data 1, image data 2, image data 3, image data 4, image data 5, image data 6, image data 7, image data 8, and image data 9. All or a portion of the image data 1, image data 2, image data 3, image data 4, image data 5, image data 6, image data 7, image data 8, and image data 9 may be associated with a particular time. For example, the image data 1 may be captured by a first sensor of the robot during a first time period, image data 2 may be captured by a second sensor of the robot during a second time period, image data 3 may be captured by a third sensor of the robot during a third time period, etc. In some cases, multiple image data may be captured during the same time period, but may be captured by different sensors of the robot (e.g., a first sensor and a second sensor).

In some cases, the log data 503 may include image data associated with the same parameter or one or more different parameters. For example, image data 1, image data 2, image data 3, image data 4, image data 5, image data 6, image data 7, image data 8, and image data 9 may be associated with the same parameter and may be stored in the same data bucket. In another example, image data 1, image data 2, and image data 3 may be associated with a first parameter and may be stored in a first data bucket, image data 4 and image data 5 may be associated with a second parameter and may be stored in a second data bucket, image data 6 may be associated with third parameter and may be stored in a third data bucket, image data 7, image data 8, and image data 9 may be associated with a fourth parameter and may be stored in a fourth data bucket.

The robot may filter and/or group the log data 503 based on the parameter data associated with the log data 503. In one example, the robot may obtain sensor data including image data 0, image data 1, image data 2, image data 3, image data 4, image data 5, image data 6, image data 7, image data 8, image data 9, image data 10, image data 11, etc. and may group image data 1, image data 2, image data 3, image data 4, image data 5, image data 6, image data 7, image data 8, and image data 9 (e.g., filter out image data 0, image data 10, image data 11, etc.) based on determining that image data 1, image data 2, image data 3, image data 4, image data 5, image data 6, image data 7, image data 8, and image data 9 are associated with a same parameter (e.g., indicating an entity is within a particular proximity of the robot). In another example, the robot may obtain sensor data including image data 0, image data 1, image data 2, image data 3, image data 4, image data 5, image data 6, image data 7, image data 8, image data 9, image data 10, image data 11, etc. and may determine image data 5 is associated with a particular parameter (e.g., a fall of the robot). The robot may group image data 1, image data 2, image data 3, image data 4, image data 5, image data 6, image data 7, image data 8, and image data 9 (e.g., filter out image data 0, image data 10, image data 11, etc.) based on determining that image data 1, image data 2, image data 3, image data 4, image data 6, image data 7, image data 8, and image data 9 are within a particular proximity (e.g., a temporal proximity of 5 seconds, 10 seconds, 30 seconds, 1 minute, etc.) of image data 5 which is associated with a particular parameter.

At step 504, the prompt system 420 identifies an input. The prompt system 420 may obtain the input from a user computing device. As discussed herein, the input may include and/or may identify one or more requests (e.g., text data indicating one or more requests in a free response format). For example, the input may include a request to identify whether a robot fell when the parameter data associated with the log data (e.g., a parameter of the log data) indicates the robot fell.

The prompt system 420 may identify particular log data (e.g., a particular data bucket and corresponding log data) based on the input. For example, the prompt system 420 may identify that the input includes a request to identify whether log data associated with a particular parameter is indicative of the particular parameter. Based on identifying that the input includes a request to identify whether log data associated with a particular parameter is indicative of the particular parameter, the prompt system 420 may identify log data (e.g., a particular data bucket) associated with the particular parameter. In the example of FIG. 5A, the input may indicate a particular parameter and the log data 503 may be associated with the particular parameter.

At step 506, the prompt system 420 filters the log data based on the input. The prompt system 420 may obtain filtered log data 507 based on filtering the log data. As discussed herein, the prompt system 420 may filter the log data by filtering image data from the log data 503 (e.g., removing one or more images from the log data 503, removing one or more portions of one or more images from the log data 503, blurring one or more images and/or one or more portions of one or more images from the log data 503, etc.

In some cases, the prompt system 420 may filter the log data 503 based on the input. For example, the input may include a request to identify an obstacle, entity, structure, or object in an environment of the robot and the prompt system 420 may filter the log data 503 to remove log data that does not include and/or indicate an obstacle, entity, structure, or object.

In the example of FIG. 5A, the prompt system 420 may filter the log data 503 and remove image data 2, image data 7, image data 8, and image data 9 from the log data 503 such that the filtered log data 507 includes image data 1, image data 3, image data 4, image data 5, and image data 6. In some cases, the prompt system 420 may filter the log data 503 such that the filtered log data 507 includes a consistent (e.g., continuous) set of log data. For example, the prompt system 420 may filter the log data 503 such that the filtered log data 507 includes a temporally continuous set of log data (e.g., log data is not filtered out that is temporally between log data to be maintained in the filtered log data).

FIG. 5B is an operation diagram 500B for performing one or more actions based on the filtered log data 507 and the input. At step 510, the prompt system 420 generates a prompt. The prompt system 420 may generate the prompt based on the input and the filtered log data 507. The prompt may include one or more images based on the filtered log data 507 and one or more questions about the one or more images based on the input. For example, the prompt may include one or more images and a question to identify whether another robot is within a particular proximity (e.g., within 1 meter, 5 meters, 10 meters, etc.) of the robot based on the one or more images.

As discussed herein, the prompt system 420 may perform prompt engineering to generate the prompt. The prompt system 420 may customize the generated prompt for the robot (e.g., such that the generated prompt is customized to the robot context). For example, to customize the generated prompt for the robot, the prompt system 420 may add text data to the prompt indicating that the prompt is associated with a robot, a legged robot, a legged robot having four legs, a legged robot having four legs where segments of the four legs form openings facing towards a front portion of the robot (e.g., facing a traversal direction of the robot) and away from a rear portion of the robot, etc.

The prompt system 420 may obtain (e.g., generate) text data based on the input and sensor data (e.g., from the filtered log data 507, from sensor data of the robot, etc.). For example, the prompt system 420 may textualize the input and the sensor data to obtain the text data. In some cases, the prompt system 420 may textualize the sensor data and combine the textualized sensor data with text data from the input to obtain text data.

As discussed herein, to generate the prompt, in some cases, the prompt system 420 may combine the text data and image data from the filtered log data 507. For example, the prompt system 420 may append the text data to images of the image data, annotate the images with the text data, etc. In some cases, the prompt system 420 may separately provide the text data and the filtered log data 507 within the prompt. For example, the prompt may include the text data within a first portion of the prompt and the filtered log data 507 within a second portion of the prompt.

At step 512, the prompt system 420 provides the prompt to a computing system. For example, the prompt system 420 may provide the prompt to the computing system via a network. The computing system may implement a machine learning model (e.g., a visual question answering model) and the prompt system 420 may provide, to the computing system, the prompt and a request to provide the prompt to the machine learning model.

The computing system may provide the prompt to the machine learning model and may obtain an output from the machine learning model. In some cases, the prompt system (or a system of the robot) may implement the machine learning model, may provide the prompt directly to the machine learning model, and/or may obtain the output directly from the machine learning model.

At step 514, the prompt system 420 obtains an output. The prompt system 420 may obtain the output from the computing system (or from the machine learning model). The output may include one or more responses to the one or more requests (e.g., one or more questions based on the input). For example, the one or more responses may indicate that the parameter data associated with particular log data indicates that an entity is within a particular proximity of the robot, however, an entity is not within a particular proximity of the robot based on the particular log data.

In some cases, output may indicate a characteristic of an image, a characteristic of an object, entity, obstacle, or structure indicated within an image, and/or a presence of an object, entity, obstacle, or structure within an image (e.g., based on image processing performed on the image). For example, the one or more responses may indicate that a first image has a characteristic (e.g., a safety rating, a slipperiness, a fall danger, a safety hazard, a fire hazard, etc.) that is greater than, less than, or equal to a characteristic of a second image. In another example, the one or more responses may indicate that an object, entity, obstacle, or structure within a first image has a characteristic (e.g., a corrosion, a rust level, a water level, an orientation, a pose, a heat level, a gas level, etc.) that is greater than, less than, or equal to a characteristic an object, entity, obstacle, or structure within a second image.

In some cases, at step 516, the prompt system 420 may identify log data 517 (e.g., a second filtered set of log data). The prompt system 420 may identify the log data 517 based on the output. In some cases, to identify the log data 517, the prompt system 420 may further filter the filtered log data 507 based on the output. For example, the output may indicate a portion of the filtered log data 507 (e.g., a portion of the filtered log data 507 corresponds to a false positive, a portion of the filtered log data 507 corresponds to a false negative, a characteristic of a portion of the filtered log data 507 is comparatively greater than, less than, or equal to a characteristic of another portion of the filtered log data 507, etc.

In the example of FIG. 5B, the log data 517 includes image data 3. For example, the prompt system 420 may identify image data 3 based on determining that image data 3 is a false positive (e.g., parameter data of the image data 3 indicates that image data 3 is associated with a slip of the robot, however, the output of the machine learning model indicates that image data 3 is not associated with a slip of the robot).

At step 518, the prompt system 420 performs one or more actions. The prompt system 420 may perform the one or more actions based on the output and/or the log data 517. In some cases, the prompt system 420 may identify the one or more actions for performance based on the input. For example, the input may include a request to perform one or more actions based on the output and/or the log data 517 (e.g., to route log data corresponding to false positives to a computing device).

In some cases, the one or more actions may include an action to provide the output and/or the log data 517 to a particular computing device. In some cases, the one or more actions may include an action to cause display of the output and/or the log data 517 via the particular computing device. For example, the output may include a sorting and/or a ranking of a plurality of images from the filtered log data 507 and the prompt system 420 may provide the sorting and/or the ranking and/or instruct display of the sorting and/or the ranking. In another example, the prompt system 420 may generate a sorting and/or a ranking of a plurality of images from the filtered log data 507 based on the output and may provide the sorting and/or the ranking and/or instruct display of the sorting and/or the ranking.

In some cases, the one or more actions may include an action to generate a graphical representation (e.g., a graph, a table, a summary, etc.) of the output and/or the log data 517. For example, the one or more actions may include an action to process the output and/or the log data 517, generate a graphical representation based on processing the output and/or the log data 517, and provide the graphical representation and/or cause display of the graphical representation.

In some cases, the one or more actions may include an action to generate a pictorial representation (e.g., a digital twin) of an environment of the robot based on the output and/or the log data 517. To generate the pictorial representation, the prompt system 420 may add a spatial component (e.g., a location based component) to the filtered log data 507 (e.g., augment the filtered log data 507 with spatial data) based on the output and may generate the pictorial representation based on the addition of the spatial component to the filtered log data 507.

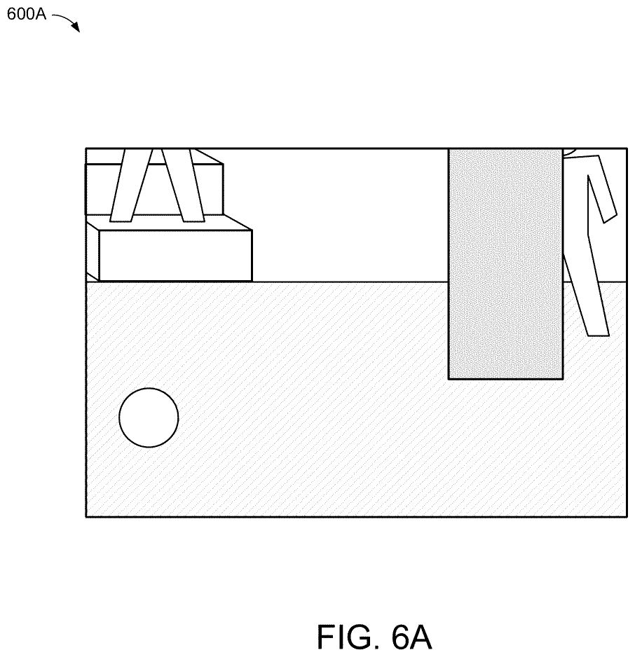

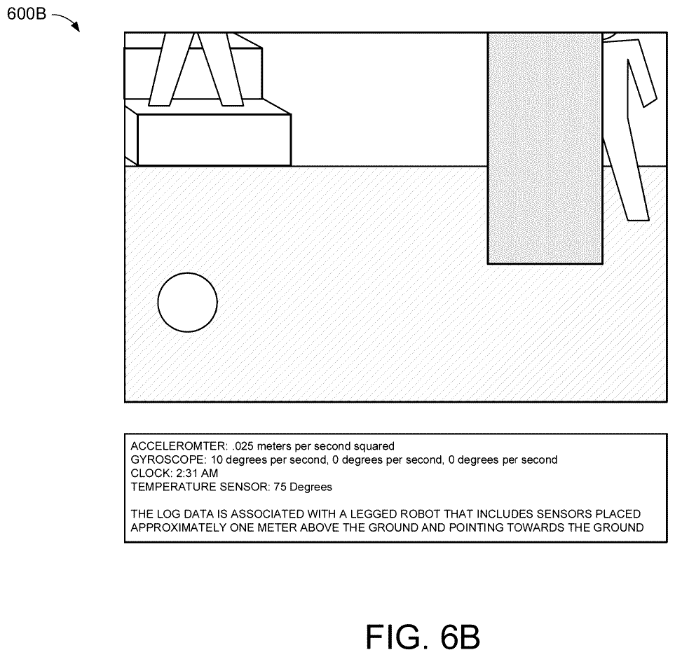

To illustrate example log data obtained by the prompt system, FIG. 6A depicts a schematic view 600A of log data. In some cases, a computing system (e.g., the computing system 140) may instruct display of a virtual representation of the log data via a user interface (of a user computing device).

The log data may include image sensor data, lidar sensor data, ladar sensor data, etc. In the example of FIG. 6A, the log data includes image sensor data. For example, the log data may be an image of a scene within the environment of the robot. The log data may indicate a plurality of objects, entities, structures, or obstacles in the environment of the robot. In the example of FIG. 6A, the log data indicates a ground surface, an object located on the ground surface, a set of stairs, a column, a first entity located on the set of stairs, and a second entity located partially behind the column. It will be understood that the environment may include more, less, or different objects, entities, structures, or obstacles.

The computing system can obtain location data identifying a location of a robot. For example, the robot can obtain the location data in response to obtaining the sensor data and may generate the log data that includes and/or indicates the location data and the sensor data. Further, the location data may indicate a location of the robot corresponding to the capture of the sensor data by one or more image sensors of the robot. For example, the location data may identify a real-time and/or historical location of the robot.

The objects, entities, structures, or obstacles within the environment may affect the robot traversing the environment (e.g., may affect how the robot traverses the environment) such that it may be important to identify the objects, entities, structures, or obstacles. In some cases, the presence of objects, entities, structures, or obstacles within the environment (e.g., within a particular proximity of the robot) while the robot is operating in a particular manner (e.g., traversing the environment) may indicate erroneous operation as the robot may be programmed to not traverse the environment when a particular object, entity, structure, or obstacle is within the environment. Therefore, it may be important to accurately identify objects, entities, structures, or obstacles within the environment (and actions performed by the robot).

To illustrate how text data may be provided with the log data to generate a prompt, FIG. 6B depicts a schematic view 600B of example log data and example text data. The schematic view 600B may include log data and text data. As discussed herein, the log data and the text data may be combined (e.g., the log data may be annotated with the text data, the text data may be appended to the log data, etc.), the log data and the text data may be combined within a prompt, and/or the log data and the text data may be separately provided.

As discussed herein, the log data may include image sensor data, lidar sensor data, ladar sensor data, etc. For example, the log data may include a camera image.

The text data may include and/or may be based on sensor data (e.g., non-image sensor data), context data, and/or an input provided by a user computing device. For example, the text data may include sensor data obtained via one or more sensors of a robot.

The text data may include and/or may be based on sensor data that may include pressure data, acceleration data, battery data (e.g., voltage data), speed data, position data, orientation data, pose data, tilt data, time data, temperature data, etc. The sensor data may correspond to the log data in that the text data may be based on sensor data (e.g., image sensor data) that corresponds to the same time period, the same environment, the same robot, etc. as the log data.

In some cases, the text data may include text data corresponding to all or a portion of the sensor data (e.g., the non-image sensor data) associated with the log data (e.g., corresponding to a same time period as the log data). In some cases, the prompt system 420 may filter the sensor data (e.g., the non-image sensor data) to identify filtered sensor data (e.g., based on the input from the user computing device) and may generate the text data based on the filtered sensor data. For example, the input may include a request to identify whether the robot flipped over and the prompt system 420 may filter the sensor data to include data relevant to the determination of whether the robot flipped over (e.g., pose data, orientation data, etc.) and exclude data not relevant to the determination of whether the robot over (e.g., time data).

In the example of FIG. 6B, the text data includes acceleration data (obtained via an accelerometer), orientation data (obtained via a gyroscope), time data (obtained via a clock), and temperature data (obtained via a temperature sensor). Further, the text data indicates that an “accelerometer” is associated with a value of “0.025 meters per second squared,” a “gyroscope” is associated with values of “10 degrees per second, 0 degrees per second, 0 degrees per second,” a “clock” is associated with a value of “2:31 AM,” and a “temperature sensor” is associated with a value of “75 degrees.”

As discussed herein, the text data may further include text data based on context data associated with the robot. For example, the prompt system 420 may perform prompt engineering and may include text data within the prompt that is based on the context data. The text data may indicate a context of the log data. For example, the text data may indicate that the log data is associated with a robot, a legged robot, a legged robot having four legs, a legged robot having four legs with sensors pointed towards a ground surface, a robot with sensors positioned approximately one meter above a ground surface and pointed towards the ground surface, a robot with a sensor on a front portion of the robot and one or more sensors on each side of the body of the robot, etc. In the example of FIG. 6B, the text data indicates that “the log data is associated with a legged robot that includes sensors placed approximately one meter above the ground and pointing towards the ground.” It will be understood that the text data may include more, less, or different text data.

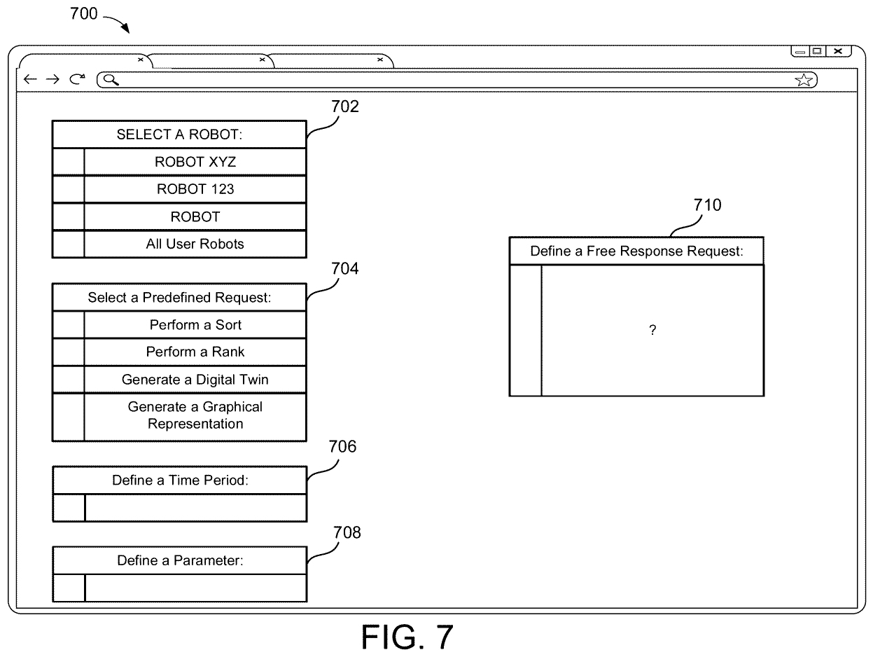

FIG. 7 is a schematic view of a user interface 700 for providing an input for generation of a prompt. The prompt system 420 may generate and provide the user interface 700 for display via a user computing device. The prompt system 420 may generate the user interface 700 based on stored log data such that the user interface enables selection of a subset of the stored log data (e.g., corresponding to a particular data bucket). For example, the prompt system 420 may generate the user interface 700 to indicate one or more robots associated with the stored log data, one or more time periods associated with the stored log data, one or more data buckets in which the log data is stored, etc. for selection. In another example, the prompt system 420 may generate the user interface 700 to indicate one or more predefined requests for selection (e.g., based on historical requests, based on requests generated by the prompt system 420, etc.). In some cases, the prompt system 420 may predict that a particular user may select a particular request (e.g., to perform a rank) based on user data and may predefine a corresponding request.

The user interface 700 may provide a first element 702, a second element 704, a third element 706, a fourth element 708, and a fifth element 710 that enable a user to provide an input. The first element 702 may enable the user to select a robot, the second element 704 may enable the user to select a predefined request, the third element 706 may enable the user to define a time period, the fourth element 708 may enable the user to define a parameter, and the fifth element 710 may enable the user to define a free response request. It will be understood that the user interface 700 may include more, less, or different elements. For example, the user interface 700 may include an element that enables a user to define a location, a particular data bucket, etc.

Based on inputs received via one or more of the first element 702, the second element 704, the third element 706, the fourth element 708, and/or the fifth element 710, the prompt system 420 can define an input for generation of a prompt. For example, the prompt system 420 can define an input indicating one or more robots, one or more requests, one or more time periods, one or more parameters, etc.

In the example of FIG. 7, the first element 702 includes the options to select “ROBOT XYZ,” “ROBOT 123,” “ROBOT,” and/or “All User Robots. ” The second element includes the options to select “Perform a Sort,” “Perform a Rank,” “Generate a Digital Twin,” and/or “Generate a Graphical Representation. ” The third element 706, the fourth element 708, and the fifth element 710 may enable a user to provide a free response input (e.g., a free response text data input).

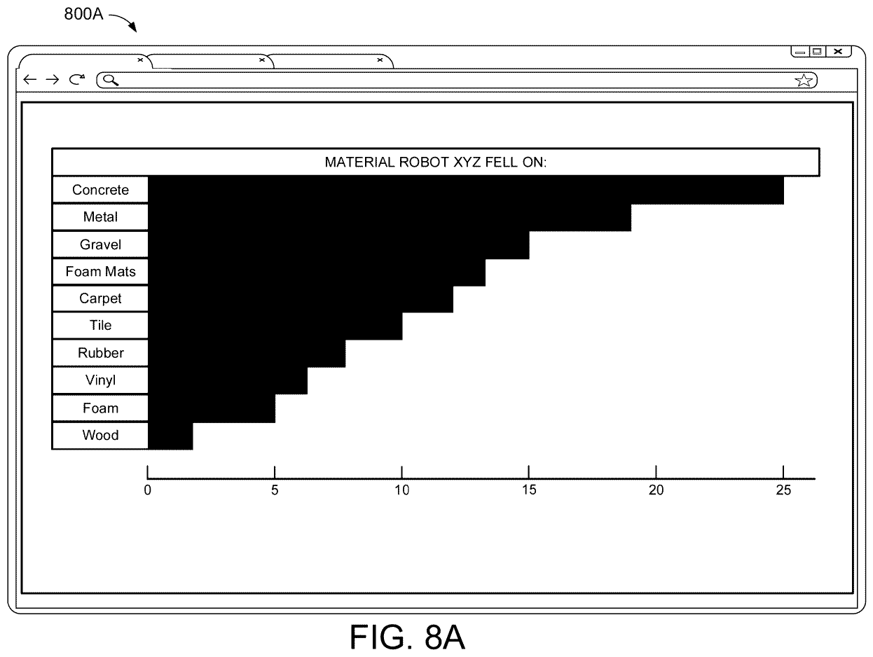

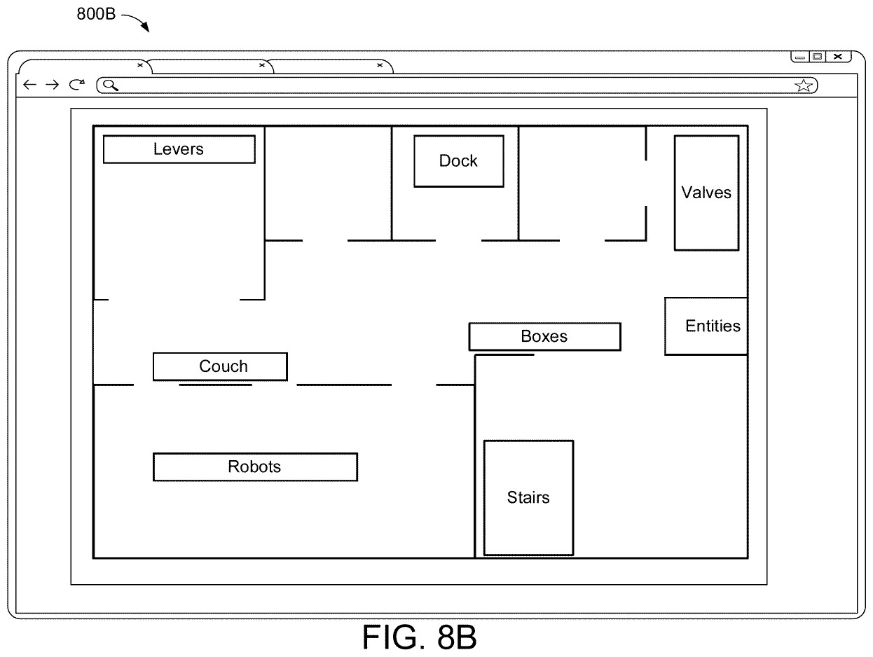

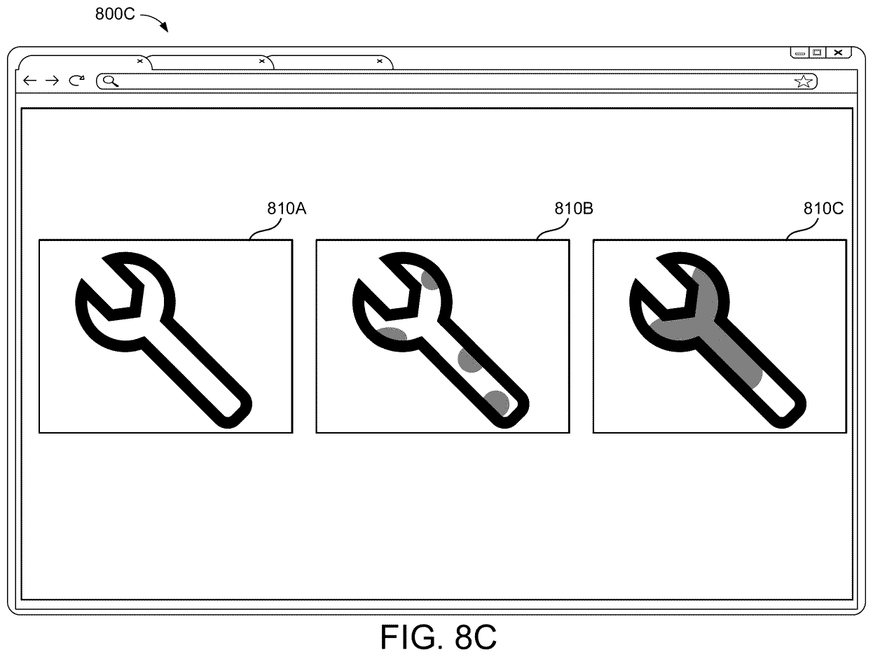

Based on the input, the prompt system 420 may generate a prompt (e.g., a prompt in the JSON format). In some cases, the prompt may define a format (e.g., JSON format) for responses to the prompt. In one example, the prompt may indicate “(1) were there any moving objects around the robot? Answer True or False, (2) of the following classes, which best describes the object the robot stopped for? select from [person, robot, vehicle, unknown], (3) where was the object when the robot stopped? select from [front, back, left, right], Your answer should be in the format: {“moving_objects”:<True or False>, “object_class”:<object class>, “location”: <object location>}.” Based on generation of the prompt, provision of the prompt to a computing system, and receipt of an output from the computing system based on the computing system providing the prompt to a machine learning model for implementation, as discussed herein, the prompt system 420 may perform one or more actions. For example, the prompt system 420 may provide the output and/or a transformed output. FIG. 8A, FIG. 8B, and FIG. 8C depict schematic views of example user interfaces providing the output and/or a transformed output. FIG. 8A is a schematic view of a user interface 800A for providing a transformed output based on an implemented prompt. The prompt system 420 may generate the transformed output and cause display of the user interface 800A based on an input received via the user interface 700. For example, the input received via the user interface 700 may indicate how to transform the output (e.g., to generate a graphical representation of the output, to generate a pictorial representation of the environment of the robot, to compare one or more images, to compare one or more objects, entities, structures, or obstacles within one or more images, to generate a ranking and/or a sorting). In the example of FIG. 8A, the input may indicate that the output of the computing system is to be transformed to generate a graphical representation of the output.

To generate the graphical representation of the output, the prompt system 420 may obtain an output indicating one or more responses of the computing system to a particular request (e.g., when the robot falls, what type of ground surface was the robot navigating on?, when the robot falls, what time of day was the robot navigating?, when the robot slips, what objects, entities, structures, or obstacles are within a particular proximity of the robot?, when the robot fails to dock, what is a status of the dock?, did the environment of the robot include a safety hazard?, did the environment include a fire hazard?, did the environment include a trip hazard, ? Did the environment include a security hazard?, did the environment include any objects that the robot could grasp with a hand member of the robot?, did the environment include any entities (e.g., humans) within a particular time period?, where are the fire extinguishers in the environment?, etc.). The prompt system 420 may generate a graphical representation for display via the user interface 800A that tracks the responses to the particular request (e.g., for a particular robot). In some cases, the prompt system 420 may continuously and/or periodically update the graphical representation.

In the example of FIG. 8A, the user interface 800A includes a graphical representation of responses to the request “When Robot XYZ fell, what is the material that Robot XYZ fell on?” The graphical representation indicates a number of falls of Robot XYZ on concrete, metal, gravel, foam mats, carpet, tile, rubber, vinyl, foam, and wood. In some cases, the graphical representation may indicate that the responses are associated with a particular time period of log data (e.g., log data collected between a first data and a second date).

FIG. 8B is a schematic view of a user interface 800B for providing a transformed output based on an implemented prompt. The prompt system 420 may generate the transformed output and cause display of the user interface 800B based on an input received via the user interface 700. For example, the input received via the user interface 700 may indicate how to transform the output. In the example of FIG. 8B, the input may indicate that the output of the computing system is to be transformed to generate a pictorial representation of the environment of the robot (e.g., a digital twin of the environment).

To generate the pictorial representation of the environment, the prompt system 420 may provide a prompt to the machine learning model requesting identification of a particular object, entity, obstacle, or structure within the environment and a location of the particular object, entity, obstacle, or structure within the environment. For example, the particular object, entity, obstacle, or structure may include a general safety hazard (e.g., a wet surface, an exposed wire, etc.), a security hazard (e.g., an open door, an entity within a particular proximity of the robot, etc.), a fire hazard (e.g., a blocked fire door, an active fire, improperly stored safety equipment), a trip hazard, etc. In another example, the particular object, entity, obstacle, or structure may include a lever, a valve, a dock, a box, a dial, a door, furniture (e.g., a couch), a set of stairs, general debris, etc.

Based on the output indicating a particular object, entity, obstacle, or structure within the environment, the prompt system 420 can identify location data of the robot indicating a particular location within the environment associated with the corresponding log data on which the output is based. The prompt system 420 can correlate the location data with the output to indicate that the particular object, entity, obstacle, or structure is located at the particular location. As discussed herein, the prompt system 420 can generate a pictorial representation of the environment that indicates that the particular object, entity, obstacle, or structure is located at the particular location (e.g., indicating a location of fire extinguishers within an environment).

The prompt system 420 may generate the pictorial representation for display via the user interface 800B. In some cases, the prompt system 420 may continuously and/or periodically update the pictorial representation.

In the example of FIG. 8B, the user interface 800B includes a pictorial representation of the environment and indicates a location of levers, a couch, a dock, boxes, valves, stairs, robots, and entities within the environment. It will be understood that the pictorial representation may indicate more, less, or different obstacles, objects, entities, or structures within the environment.

FIG. 8C is a schematic view of a user interface 800C for providing a transformed output based on an implemented prompt. The prompt system 420 may generate the transformed output and cause display of the user interface 800C based on an input received via the user interface 700. For example, the input received via the user interface 700 may indicate how to transform the output. In the example of FIG. 8C, the input may indicate that the output of the computing system is to be transformed to generate a sorting and/or ranking of two or more images (e.g., a sorting and/or ranking of objects, entities, obstacles, or structures within two or more images) based on characteristics of the two or more images (e.g., condition, age, size, orientation, etc.). In some cases, the output may include the sorting and/or the ranking. For example, the machine learning model may provide the sorting and/or the ranking.

To generate the sorting and/or the ranking, the prompt system 420 may implement a visual search of two or more images of the log data. To implement the visual search, the prompt system 420 may generate a comparison-based prompt. For example, the comparison-based prompt “Which wrench is more corroded? Answer only with A or B. If they are approximately the same, answer ‘=’”. In some cases, the prompt system 420 may generate a comparison-based prompt for one or more subsets of images of the log data. For example, the prompt system 420 may generate a first comparison-based prompt for comparision of a first image and a second image, a second comparison-based prompt for comparison of a second image and a third image, etc. The prompt system 420 may generate the sorting and/or ranking based on the comparison-based prompt(s).

In some cases, the prompt system 420 may generate a visual top K based on the comparison-based prompt(s). For example, the comparison-based prompt(s) may be based on a request to identify K images (e.g., the K most interesting images) where K can be any number. In some cases, the prompt may continuously and/or periodically update the sorting, ranking, and/or visual top K (e.g., as additional log data is obtained).

The prompt system 420 may generate the sorting, ranking, and/or visual top K for display via the user interface 800B. In some cases, the sorting, ranking, and/or visual top K may include a rank (e.g., a placement, a hierarchy, etc.), a sort, a distribution, etc. of the images.

In the example of FIG. 8C, the prompt is to sort wrenches according to a level of corrosiveness of the wrenches and user interface 800C includes a first pictorial representation of a first wrench 810A, a second pictorial representation of a second wrench 810B, and a third pictorial representation of a third wrench 810C. Further, the user interface 800C indicates the first wrench is less corroded as compared to the second wrench and the third wrench and the second wrench is less corroded as compared to the third wrench based on the output of the machine learning model. It will be understood that the pictorial representation may indicate a comparison of more, less, or different obstacles, objects, entities, or structures within the environment and/or a comparison of different characteristics of the obstacles, objects, entities, or structures within the environment.

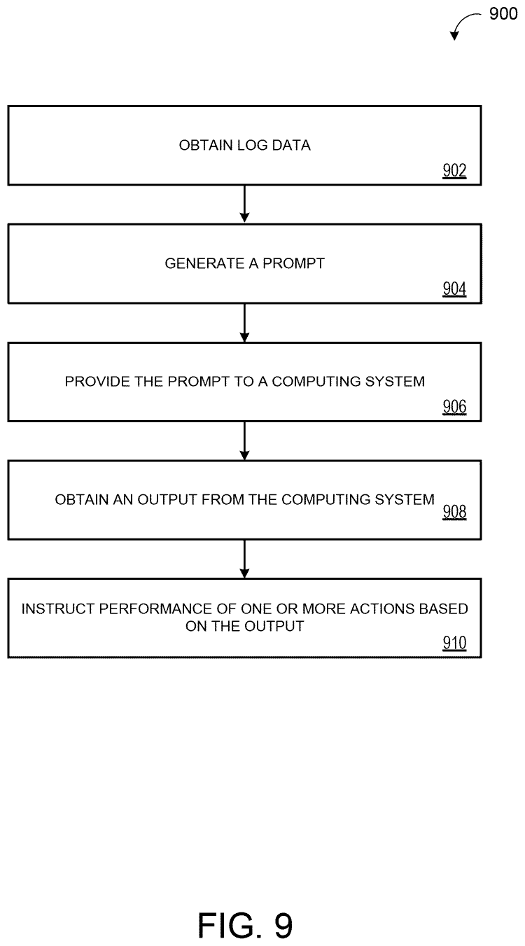

FIG. 9 is a flowchart of an example arrangement of operations for instructing performance of one or more actions based on a generated and implemented prompt. The prompt may be generated based on log data associated with a robot. For example, the robot may be a legged robot with a set of legs (e.g., two or more legs, four or more legs, etc.), memory, and a processor. Further, the computing system may be a computing system of the robot. In some cases, the computing system of the robot may be located on and/or part of the robot. In some cases, the computing system of the robot may be distinct from and located remotely from the robot. For example, the computing system of the robot may communicate, via a local network, with the robot. The computing system may be similar, for example, to the prompt system 420 as discussed herein, and may include memory and/or data processing hardware.

At block 902, the computing system obtains log data. The log data may be associated with one or more mobile robots (e.g., one or more quadruped robots) that may be configured to traverse an environment. For example, the one or more mobile robots may generate sensor data based on traversal of the environment and the one or more mobile robots (or a separate system) may generate the log data based on the sensor data. In another example, the computing system may obtain a first portion of the log data from a first mobile robot of the one or more mobile robots and a second portion of the log data from a second mobile robot of the one or more mobile robots. The first portion of the log data may be captured via one or more first sensors of the first mobile robot and the second portion of the log data may be captured via one or more second sensors of the second mobile robot.

The log data may include image data (e.g., a plurality of images) and non-image sensor data (e.g., pressure data, acceleration data, battery data, speed data, position data, orientation data, pose data, tilt data, time data, temperature data, etc.). For example, the log data may include a plurality of images and one or more timestamps for all or a portion of the plurality of images.

The computing system may obtain an input (e.g., from a user computing device). The input may include one or more requests (e.g., one or more questions). For example, the one or more requests may include one or more questions requesting comparison (e.g., a visual comparison, a visual comparison operation, etc.) of two or more objects, entities, obstacles, or structures as indicated by the at least a portion of the log data. The comparison may be a comparison of characteristics of the images (e.g., a comparison of characteristics of the two or more objects, entities, obstacles, or structures). In some cases, the comparison may be a comparison of the same object, entity, obstacle, or structure but based on sensor data captured at different time periods, from different viewpoints, etc. In another example, the one or more requests may include a request to compare a first image of the log data to a second image of the log data. In another example, the one or more requests may include one or more multiple choice questions. By limiting the possible responses (e.g., answers) to a question, the computing system can improve the efficiency and accuracy of a machine learning model.

In some cases, the computing system may instruct at least one of the one or more mobile robots to perform one or more operations (e.g., to traverse an environment). Performance of the one or more operations may cause the at least one mobile robot to generate the log data.

At block 904, the computing system generates (e.g., dynamically generates) a prompt. The prompt may be a prompt for a machine learning model (e.g., a visual question answering model). The computing system may generate the prompt based on the log data and the input (e.g., text data). The prompt may include at least a portion of the log data and the one or more requests (e.g., based on the input). For example, the prompt may include at least a portion of the log data and one or more questions. In another example, the prompt may include sensor data generated by the one or more mobile robots.

In some cases, the computing system may generate text data based on sensor data (e.g., non-image sensor data obtained from the one or more mobile robots). The text data may include and/or indicate one or more textual values based on the sensor data. The computing system may include the text data within the prompt.

To identify the at least a portion of the log data, the computing system may identify parameters associated with (e.g., assigned to) the log data. For example, a parameter may indicate that the one or more mobile robots stopped for a moving object, an entity, etc., fell, are stuck, are unable to dock, successfully docked, turned off, turned on, initiation or completion of recording operation, etc. In some cases, the one or more mobile robots may implement one or more machine learning models trained to output one or more parameters based on log data and the one or more mobile robots may assign the one or more parameters to the log data based on the output.

The log data may be stored in (e.g., may be segmented across) one or more data buckets and all or a portion of the one or more data buckets may be associated with a respective parameter such that the log data is stored in the one or more data buckets according to the parameters of the log data. In one example, all or a portion of the one or more data buckets may be associated with a respective event (e.g., the robot falling) and at least one timestamp indicative of an occurrence of the event (e.g., a data buckets may include log data associated with falls of the one or more mobile robots between 4:00 PM and 6:00 PM on Jan. 23, 2024).

The input may indicate one or more parameters. For example, the input may include a request to identify what caused a robot to stop when it is determined that a robot stopped and the relevant parameter may be that the robot stopped. In another example, the input may include one or more timestamps.

The computing system may search all or a portion of a plurality of data buckets based on the input to obtain the log data and/or the at least a portion of the log data. For example, based on the one or more parameters indicated by the input (e.g., a timestamp), the computing system may filter the log data to identify the at least a portion of the log data. The computing system may identify one or more data buckets associated with the one or more parameters and may filter the log data by obtaining log data stored in (e.g., segmented into) the one or more data buckets but excluding log data stored in other data buckets. For example, the computing system may filter the log data to identify the at least a portion of the log data based on parameters of the log data (e.g., one or more values of the log data) indicating that the one or more mobile robots stopped for a moving object, an entity, etc., fell, are stuck, are unable to dock, successfully docked, turned off, turned on, initiation or completion of recording operation, etc.

In some cases, to filter the log data, the computing system may filter a plurality of images of the log data to identify a first image of the plurality of images such that the at least a portion of the log data includes the first image and excludes a second image of the plurality of images. In some cases, to filter the log data, the computing system may filter an image of the log data to identify a first portion of the image such that the at least a portion of the log data includes the first portion of the image and excludes a second portion of the image. In some cases, to filter the log data, the computing system may filter the plurality of images based on a temporal proximity (e.g., within 30 seconds, within 1 minute, etc.) of the plurality of images to a timestamp associated with an event (e.g., the one or more mobile robots becoming stuck) to obtain a filtered plurality of images that correspond to the at least a portion of the log data In some cases, the prompt may include the one or more parameters. For example, the prompt may include the one or more parameters based on the input.

In some cases, the prompt may include at least one of sensor data or synthetic image data. The computing system may generate synthetic image data based on the sensor data. The synthetic image data may include a synthetic image indicating one or more obstacles, entities, structures, or objects within an environment.

In some cases, the prompt may include context data. For example, the context data may indicate that the at least a portion of the log data is associated with the one or more mobile robots, is associated with the one or more mobile robots that are located within a particular proximity of a ground surface (e.g., 1 meter), is associated with the one or more mobile robots traversing the environment, is associated with (e.g., generated by) one or more sensors of the one or more mobile robots, is associated with the one or more mobile robots and all or a portion of the one or more mobile robots may include two or more legs, etc.

At block 906, the computing system provides the prompt (e.g., for the machine learning model) to a computing system (e.g., a first computing system). For example, the computing system may implement the machine learning model and may provide the prompt to the machine learning model as an input (e.g., for implementation of the prompt). The computing system may obtain an output from the machine learning model based on providing the prompt to the machine learning model.

In some cases, the computing system may separately provide the text data, the context data, the input, and the at least a portion of the log data (e.g., image data) as the prompt to the computing system.

At block 908, the computing system obtains an output from the computing system. The output may include one or more responses to the prompt. For example, where the prompt includes a request to identify, when a robot stopped, why the robot stopped, the one or more responses may indicate at least one of a presence, a class, a status, etc. of an object, entity, structure, or obstacle around a respective mobile robot of the one or more mobile robots. The one or more responses may include one or more responses in JSON format (e.g., JSON data format).

In some cases, the output may include at least one of a flag, an alert (e.g., a visual alert), a visual top K, a ranking, a sort, an indication that the at least a portion of the log data is associated with an error and/or a false positive (e.g., the at least a portion of the log data is erroneously stored in a particular data bucket), etc. For example, the output may include an alert of an anomalous condition (e.g., a water leak, a fire, etc.). In some cases, the computing system may transform the output and generate a transformed output that includes at least one of a flag, an alert, a visual alert, a visual top K, a ranking, an indication that the at least a portion of the log data is associated with an error and/or a false positive, etc.

At block 910, the computing system instructs (e.g., commands, controls, etc.) performance of one or more actions (e.g., by the one or more mobile robots, by a different robot, by a different computing system, by the computing system, etc.) based on the output. For example, the computing system may provide instructions to perform the one or more actions. In some cases, to instruct performance of the one or more actions, the computing system may generate instructions and provide (e.g., output) the instructions to a system (e.g., to a robot, a different computing system, etc.). The system may execute the instructions and may perform the one or more actions based on obtaining the instructions from the computing system.

In one example of the one or more actions, the computing system may provide the output to a database. For example, the computing system may store the output in the database. In some cases, the computing system may provide a link to storage of the output in the database to a user computing device. In some cases, the computing system may provide access to the database to the user computing device to enable the user computing device to access the output.

In another example of the one or more actions, the computing system may provide the output (e.g., directly) to a second computing system. For example, the computing system may provide the output to a user computing device.

In another example of the one or more actions, the computing system may instruct display of a user interface via a user computing device based on the output. The user interface may indicate a graphical representation based on the output, a pictorial representation of the environment (e.g., a digital twin), a result indicative of performance of a visual comparison operation, etc.

In another example of the one or more actions, the computing system may identify segmentation of a portion of the log data into a particular data bucket is a false positive based on the output. For example, the particular data bucket may be associated with a parameter indicating that an entity is within a particular proximity of a robot and the output may indicate that an entity is not within a particular proximity of the robot. In response to and based on identifying the segmentation is a false positive, the computing system may remove the portion of the log data from the particular data bucket and/or may dissociate the portion of the log data and the particular data bucket. In some cases, the computing system may remove the portion of the log data from the particular data bucket and add the data to a different data bucket of a plurality of data buckets based on the output.

In another example of the one or more actions, the computing system may instruct performance of one or more actions by the one or more mobile robots based on the output. For example, the computing system may instruct traversal of an environment by the one or more mobile robots based on the output and generation of additional log data by the one or more mobile robots based on the traversal of the environment. In some cases, the computing system may instruction generation of additional log data according to log data generation criteria (e.g., indicating a manner of generating the log data) that the computing system may identify based on the output. For example, the log data generation criteria may indicate one or more of a portion of the environment for generation of log data, a time period for generation of log data, a sensor of the one or more mobile robots for generation of log data, sensor data for generation of log data, a state of the one or more mobile robots for generation of log data, an object for generation of log data, an obstacle for generation of log data, a structure for generation of log data, or an entity for generation of log data. In some cases, the computing system may instruct performance of one or more actions (e.g., traversal of an environment and generation of additional log data) by a different mobile robot.

In another example of the one or more actions, the computing system may train the one or more machine learning models implemented by the one or more mobile robots based on the output. For example, the output may indicate that the log data is associated with one or more false positives (e.g., assignment of a parameter to the log data was in error) and the computing system may train the one or more machine learning models based on the one or more false positives.

In another example of the one or more actions, the computing system may annotate the log data based on the output to obtain annotated log data (e.g., indicating the output) and may provide the annotated log data to a database.

In another example of the one or more actions, the computing system may generate a pictorial representation of the environment (e.g., a digital twin) and may instruct display of the pictorial representation via a user interface of a user computing device. To generate the pictorial representation, the computing system may generate a spatially augmented output based on the prompt and the output and may instruct display of the spatially augmented output overlaid on a representation of the environment via a user interface of a user computing device.

In another example of the one or more actions, the computing system may filter the log data (and/or the at least a portion of the log data) based on the output to identify filtered log data. The computing system may provide the filtered log data to a second computing system.

In another example of the one or more actions, the computing system may transform the output (e.g., to generate a graphical representation of the output, a pictorial representation of the environment, a sorting, a ranking, a top K, etc.) to generate a transformed output (e.g., a second output) and may provide the transformed output to database. For example, the computing system may generate the transformed output based on the prompt and output and may instruct display of the transformed output via a user interface of a user computing device.

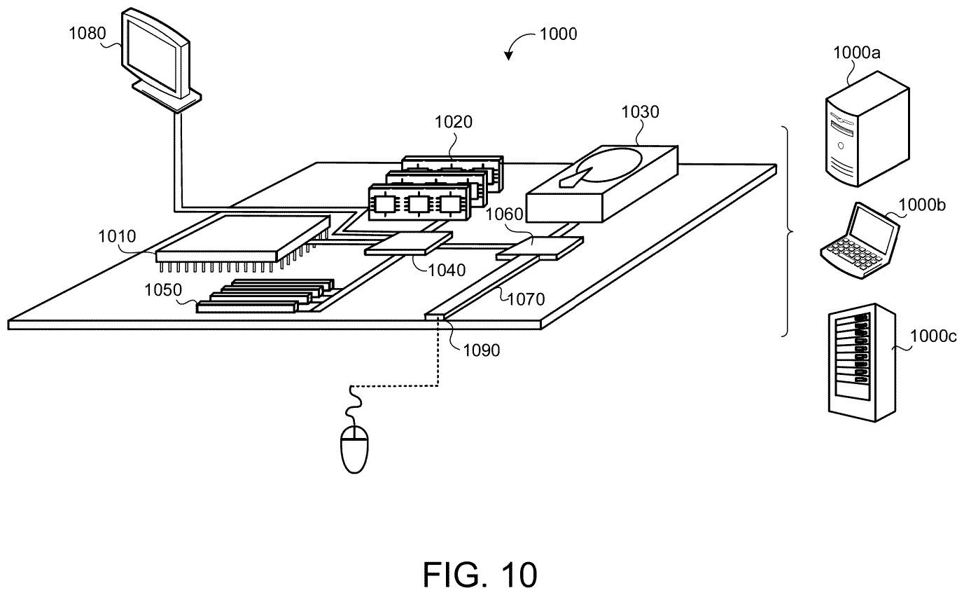

FIG. 10 is schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1000 includes a processor 1010, memory 1020 (e.g., non-transitory memory), a storage device 1030, a high-speed interface/controller 1040 connecting to the memory 1020 and high-speed expansion ports 1050, and a low-speed interface/controller 1060 connecting to a low-speed bus 1070 and a storage device 1030. All or a portion of the processor 1010, the memory 1020, the storage device 1030, the high-speed interface/controller 1040, and/or the high-speed expansion ports 1050 may be interconnected using various busses, and may be mounted on a common motherboard or in other manners as appropriate. The processor 1010 can process instructions for execution within the computing device 1000, including instructions stored in the memory 1020 or on the storage device 1030 to display graphical information for a graphical user interface (GUI) on an external input/output device, such as display 1080 coupled to the high-speed interface/controller 1040. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1020 stores information non-transitorily within the computing device 1000. The memory 1020 may be a computer-readable medium, a volatile memory unit(s), or non-volatile memory unit(s). The memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1030 is capable of providing mass storage for the computing device 1000. In some implementations, the storage device 1030 is a computer-readable medium. In various different implementations, the storage device 1030 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described herein. The information carrier is a computer-or machine-readable medium, such as the memory 1020, the storage device 1030, or memory on processor 1010.

The high-speed interface/controller 1040 may manage bandwidth-intensive operations for the computing device 1000, while the low-speed interface/controller 1060 may manage lower bandwidth-intensive operations. Such allocation of duties is exemplary only. In some implementations, the high-speed interface/controller 1040 may be coupled to the memory 1020, the display 1080 (e.g., through a graphics processor or accelerator), and to the high-speed expansion ports 1050, which may accept various expansion cards (not shown). In some implementations, the low-speed interface/controller 1060 may be coupled to the storage device 1030 and a low-speed expansion port 1090. The low-speed expansion port 1090, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1000a or multiple times in a group of such servers, as a laptop computer 1000b, or as part of a rack server system 1000c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user. In some cases, interaction is facilitated by a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Furthermore, the elements and acts of the various embodiments described herein can be combined to provide further embodiments. Indeed, the methods and systems described herein may be embodied in a variety of other forms; furthermore, various omissions, substitutions, and changes in the form of the methods and systems described herein may be made without departing from the spirit of the disclosure. Accordingly, other implementations are within the scope of the following claims.

What is claimed is:

1. A method comprising:
obtaining, by data processing hardware, log data associated with one or more mobile robots, the one or more mobile robots configured to traverse an environment;
generating, by the data processing hardware, a prompt for a machine learning model, wherein the prompt for the machine learning model comprises at least a portion of the log data and one or more questions;
providing, by the data processing hardware, the prompt for the machine learning model to a computing system;
obtaining, by the data processing hardware, an output from the computing system, wherein the output comprises one or more responses to the prompt for the machine learning model; and
instructing, by the data processing hardware, performance of one or more actions based on the output.

2. The method of claim 1, wherein the prompt for the machine learning model indicates that the at least a portion of the log data is associated with the one or more mobile robots and each of the one or more mobile robots comprises two or more legs.

3. The method of claim 1, wherein the one or more questions comprises one or more questions requesting a comparison of two or more objects as indicated by the at least a portion of the log data.

4. The method of claim 1, wherein the log data comprises sensor data and one or more parameters, wherein the one or more parameters indicate the one or more mobile robots stopped for a moving object, the method further comprising:
filtering the log data to identify the at least a portion of the log data based on the one or more parameters, wherein the one or more responses indicate at least one of a presence, class, or status of an object around a respective robot of the one or more mobile robots.

5. The method of claim 1, wherein the log data is segmented into a plurality of data buckets, wherein each of the plurality of data buckets is associated with a respective parameter, the method further comprising:
filtering the log data to identify the at least a portion of the log data associated with a particular data bucket of the plurality of data buckets, wherein the at least a portion of the log data comprises a portion of the log data segmented into the particular data bucket, wherein the prompt further comprises a particular parameter associated with the particular data bucket,
wherein instructing performance of the one or more actions comprises:
identifying segmentation of the portion of the log data into the particular data bucket is associated with at least one false positive based on the output; and
removing the portion of the log data from the particular data bucket based on identifying the segmentation of the portion of the log data into the particular data bucket is associated with the at least one false positive.

6. The method of claim 1, wherein the log data is associated with a particular data bucket of a plurality of data buckets, wherein each of the plurality of data buckets is associated with a respective parameter, wherein instructing performance of the one or more actions comprises:
identifying association of a portion of the log data and the particular data bucket is associated with at least one false positive based on the output; and
disassociating the portion of the log data and the particular data bucket based on identifying the association of the portion of the log data and the particular data bucket is associated with at least one false positive.

7. The method of claim 1, wherein the log data is segmented into a plurality of data buckets, wherein each of the plurality of data buckets is associated with a respective event and at least one timestamp indicative of an occurrence of the respective event, the method further comprising:
filtering the log data to identify the at least a portion of the log data associated with a particular data bucket of the plurality of data buckets.

8. The method of claim 1, wherein the log data comprises a plurality of images corresponding to a particular data bucket of a plurality of data buckets, wherein each of the plurality of data buckets is associated with a respective event and at least one timestamp indicative of an occurrence of the respective event, the method further comprising:
identifying a timestamp associated with the particular data bucket; and
filtering the plurality of images based on the timestamp to obtain a filtered plurality of images corresponding to the at least a portion of the log data, wherein the filtered plurality of images includes a first image of the plurality of images and excludes a second image of the plurality of images.

9. The method of claim 1, wherein instructing performance of the one or more actions comprises:
generating a spatially augmented output based on the prompt for the machine learning model and the output; and
instructing display of the spatially augmented output overlaid on a pictorial representation of the environment of the one or more mobile robots via a user interface of a user computing device.

10. The method of claim 1, wherein the one or more mobile robots implement one or more machine learning models, wherein instructing performance of the one or more actions comprises:
training the one or more machine learning models based on the output.

11. The method of claim 1, wherein the one or more mobile robots implement one or more machine learning models, wherein instructing performance of the one or more actions comprises:
identifying one or more false positives associated with the log data based on the output; and
training the one or more machine learning models based on the one or more false positives.

12. The method of claim 1, wherein instructing performance of the one or more actions comprises:
identifying one or more log data generation criteria based on the output, wherein the one or more log data generation criteria indicate one or more of:
a portion of the environment for generation of log data,
a time period for generation of log data,
a sensor of the one or more mobile robots for generation of log data,
sensor data for generation of log data,
a state of the one or more mobile robots for generation of log data,
an object for generation of log data,
an obstacle for generation of log data,
a structure for generation of log data, or
an entity for generation of log data,
instructing traversal of the environment by the one or more mobile robots based on the output; and
instructing generation of additional log data by the one or more mobile robots based on the traversal of the environment and the one or more log data generation criteria.

13. The method of claim 1, wherein obtaining the log data comprises:
obtaining a first portion of the log data from a first mobile robot of the one or more mobile robots and a second portion of the log data from a second mobile robot of the one or more mobile robots, wherein the first portion of the log data is captured via one or more first sensors of the first mobile robot and the second portion of the log data is captured via one or more second sensors of the second mobile robot.

14. The method of claim 1, further comprising:
filtering the log data to identify the at least a portion of the log data based on one or more values of the log data.

15. The method of claim 1, further comprising:
filtering the log data to identify the at least a portion of the log data based on one or more values of the log data indicating the one or more mobile robots at least one of have fallen, are stuck, are lost, are unable to dock, are turned off, or are recording.

16. The method of claim 1, wherein instructing performance of the one or more actions comprises:
generating instructions; and
outputting the instructions, the method further comprising:
performing the one or more actions based on outputting the instructions.

17. The method of claim 1, wherein the output comprises at least one of a flag, an alert, a visual sort, visual top K, or a ranking.

18. The method of claim 1, wherein the one or more responses comprise one or more responses in JSON data format.

19. A system comprising:
data processing hardware; and
memory in communication with the data processing hardware, the memory storing instructions that when executed on the data processing hardware cause the data processing hardware to:
obtain log data associated with one or more mobile robots, the one or more mobile robots configured to traverse an environment;
generate a prompt for a machine learning model, wherein the prompt for the machine learning model comprises at least a portion of the log data and one or more questions;
provide the prompt for the machine learning model to a computing system;
obtain an output from the computing system, wherein the output comprises one or more responses to the prompt for the machine learning model; and
instruct performance of one or more actions based on the output.

20. The system of claim 19, wherein the prompt for the machine learning model indicates that the at least a portion of the log data is associated with the one or more mobile robots within a particular proximity of a ground surface.

21. The system of claim 19, wherein the log data comprises image data, wherein the one or more questions comprises one or more questions requesting a comparison of at least a first image of the image data to a second image of the image data.

22. The system of claim 19, wherein the log data is segmented into a plurality of data buckets, wherein each of the plurality of data buckets is associated with a respective parameter, wherein execution of the instructions on the data processing hardware further causes the data processing hardware to:
filter the log data to identify the at least a portion of the log data associated with a particular data bucket of the plurality of data buckets, wherein the at least a portion of the log data comprises a portion of the log data segmented into the particular data bucket, wherein the prompt further comprises a particular parameter associated with the particular data bucket.

23. A robot comprising:
at least one sensor;
at least two legs;
data processing hardware in communication with the at least one sensor; and
memory in communication with the data processing hardware, the memory storing instructions that when executed on the data processing hardware cause the data processing hardware to:
obtain log data associated with one or more mobile robots, the one or more mobile robots configured to traverse an environment;
generate a prompt for a machine learning model, wherein the prompt for the machine learning model comprises at least a portion of the log data and one or more questions;
provide the prompt for the machine learning model to a computing system;
obtain an output from the computing system, wherein the output comprises one or more responses to the prompt for the machine learning model; and
instruct performance of one or more actions based on the output.

24. The robot of claim 23, wherein the log data corresponds to a particular data bucket of a plurality of data buckets, wherein each of the plurality of data buckets is associated with a respective parameter, wherein to instruct performance of the one or more actions, execution of the instructions on the data processing hardware further causes the data processing hardware to:
identify association of a portion of the log data and the particular data bucket is associated with at least one false positive based on the output;
remove the portion of the log data from the particular data bucket based on identifying the association of the portion of the log data and the particular data bucket is associated with at least one false positive; and
add the portion of the log data to a different data bucket of the plurality of data buckets.

25. The robot of claim 23, wherein the log data comprises a plurality of images, wherein execution of the instructions on the data processing hardware further causes the data processing hardware to:
filter the plurality of images to identify a portion of a first image of the plurality of images, wherein the at least a portion of the log data comprises the portion of the first image.
